(19) United States
(12) Patent Application Publication
(10) Pub. No.: US 2026/0346583 A1
(43) Pub. Date: Nov. 5, 2026

(54) PRINTABLE PLASTICS FILM FOR PRODUCTION OF SECURITY DOCUMENTS

(71) Applicant: Covestro Deutschland AG, Leverkusen (DE)

(72) Inventors: Georgios Tziovaras, Neuss (DE); Roland Kuenzel, Leverkusen (DE); Theivanayagam Deivaraj, Düsseldorf (DE); Christoph Koehler, Duisburg (DE); Holger Schmeer, Köln (DE); Stefan Janke, Brüggen (DE); Daniel Hentschel, Odenthal (DE)

(21) Appl. No.: 19/485,523

(22) PCT Filed: May 23, 2024
(86) PCT No.: PCT/EP2024/064299

§ 371 Date: Nov. 18, 2025

(30) Foreign Application Priority Data
May 30, 2023 (EP) 23176022.4

(51) Int. Cl. B32B 25/08; B32B 25/14; B32B 27/20; B32B 27/40

(52) U.S. Cl. CPC B32B 25/08; B32B 25/14; B32B 27/20; B32B 27/40; B32B 2250/03; B32B 2255/10; B32B 2307/536; B32B 2307/54; B32B 2307/5825; B32B 2425/00

(57) ABSTRACT

The invention relates to a security document S having a first outer side AS1 and a second outer side AS2 opposite the first outer side AS1 comprising at least: A5. A first polymer film A1, A6. optionally a second polymer film A2, A7. optionally at least one further polymer film A3, A8. a printing layer A4, 10. wherein at least the first polymer film A1 comprises a thermoplastic polyurethane TPU having a hardness in the range from 80 Shore A to 95 Shore D, preferably from 85 Shore A to 90 Shore D, particularly preferably from 90 Shore A to 85 Shore D, very particularly preferably from 95 Shore A to 80 Shore D, in an amount in a range from 50% to 100% by weight based on the total weight of the first polymer film A1 and forms at least the outer side AS1 of the security document S and wherein the printing layer A4 covers the surface of the security document S in a range from 1% to 100% based on the total surface area of the surface AS1, and to a process for producing such a security document S and to the use thereof and to the use of a TPU having a Shore hardness in a range from 80 Shore A to 95 Shore D for producing a polymer film A1 which is printable with dyes of the class of offset printing inks, flexographic printing inks, screen printing inks, digital printing inks with a resolution of 20 μm to 500 μm.

The invention relates to a security document S having at least one polymer film A1 and optionally A2, and also optionally further polymer films A3, a print layer A4, wherein at least the first polymer film A1 comprises a thermoplastic polyurethane TPU having a hardness in a range from 80 Shore A to 95 Shore D in an amount in a range from 50% to 100% by weight and forms at least one of the outer sides AS1 or AS2 of the security document S, and wherein the print layer A4 covers the surface of the security document S in a range from 1% to 100%, preferably from 10% to 90%, based on the total surface area of the surface AS1.

Printing substrates for value documents such as for example banknotes are subject to constant development to be able to meet the likewise ever increasing demands on durability, efficiency, forgery resistance and sustainability. To increase the service life of banknotes but also security documents such as passports there is an increasing trend for replacing security documents, especially banknotes, made of paper with banknotes made of polymer films. Banknotes based on plastic films contribute to the sustainability of the means of payment by enabling the service life of the banknotes or other security documents to be increased by a factor of 2 to 3 and by increasing the reusability of the material. As a result, significantly less energy, material and natural resources are required for the production of banknotes and other security documents. In addition, the longer service life of the banknotes and other security documents makes it possible to achieve significant cost savings. Thus for example Australia from 1988 introduced banknotes where a polymer film serves as the printing substrate.

The production of banknotes from polymer films today employs almost exclusively films based on polyolefins which are biaxially stretched (oriented) after extrusion (BOPP), as described in U.S. Pat. No. 5,879,028 A. As a consequence of the process, these films can only be produced as transparent films. The films are subsequently coated to obtain a white opaque color and to improve the printability of the film. In a few exceptions, the production of banknotes employs composites of film with paper or other materials, for example cotton fibers, as described in WO06066431 A1. The outer paper layers form the alternative to the white coating of the BOPP films.

A disadvantage of the films consisting of BOPP is the fact that BOPP is a polymer that is used in similar quality in countless products of everyday use such as packaging films, transparent films, sealing films etc. and is therefore readily available for imitations to a potential forger. The fact that the substrate used is an oriented film proves disadvantageous especially when the substrate is exposed to elevated temperatures such as may, however, readily occur in everyday use, but also when the film is being printed.

Biaxially oriented polypropylene exhibits very high shrinkage at higher temperatures. Thus for example at a temperature above about 100 °C a polymer banknote made of biaxially stretched polypropylene was found to undergo shrinkage in length and width of up to 20% of its original length and width. These polymer banknotes also undergo different degrees of shrinkage in length and width thus leading to distortion of the banknote and thus of the print image generally applied thereto. A further disadvantage of the polymer banknotes known hitherto, in particular the polymer banknotes based on biaxially stretched polyolefins, is that the above-described shrinkage is irreversible. In the vicinity of a heated hotplate or else under a halogen lamp or during printing processes in which heat is generated or used, it may well happen that such a polymer banknote undergoes irreversible contraction.

Complex and cost-intensive production processes are necessary, especially to achieve the desired opacity of the film and also the necessary surface energy to allow the take-up of printing inks. The tear propagation resistance is also particularly low for BOPP films. A minimal tear in the banknote will result in immediate failure of the banknote.

Both polyolefin-based films and composite films exhibit the abovementioned disadvantages and there is therefore a need to minimize or even eliminate these disadvantages.

An object of the invention was to develop a process of the type in question and a security document of the type in question, for example in the form of a polymer printing substrate such as a banknote or a passport, in such a way that the disadvantages of the prior art are at least partly overcome, in particular to increase the forgery resistance of the security document, in particular through a stable and high-resolution print layer.

It was a further object of the invention to provide a security document which meets the present demands on durability, efficiency, in particular resource-efficiency, forgery resistance and/or sustainability while in particular meeting none of these demands less well than is the case in the present prior art.

It was yet a further object of the invention to provide a security document which, as far as possible without further pretreatment, has sufficient surface energy to allow take-up of printing inks.

It was a further object of the invention to provide an optimized, in particular more cost-effective, process for a printed security document, having the recited advantages.

A first aspect of the invention is a security document S having a first outer side AS1 and a second outer side AS2 opposite the first outer side AS1, comprising at least:
A1. a first polymer film A1,
A2. optionally a second polymer film A2,
A3. optionally at least one further polymer film A3,
A4. a print layer A4,

wherein at least the first polymer film A1 comprises a thermoplastic polyurethane TPU having a hardness in a range from 80 Shore A to 95 Shore D, preferably from 85 Shore A to 90 Shore D, more preferably from 90 Shore A to 85 Shore D, very preferably from 95 Shore A to 80 Shore D, very preferably from 60 Shore D to 90 Shore D, in an amount in a range from 50% to 100% by weight and forms at least one of the outer sides AS1 or AS2 of the security document S, and wherein the print layer A4 covers the surface of the security document S in a range from 1% to 100%, preferably from 10% to 90%, based on the total surface area of the surface AS1.

Preferably, the entire polymer film A1 has a hardness in a range from 80 Shore A to 95 Shore D, preferably from 90 Shore A to 90 Shore D, more preferably from 60 Shore D to 90 Shore D. Furthermore, the entire security document S preferably has a hardness in a range from 80 Shore A to 95 Shore D, preferably from 90 Shore A to 90 Shore D, more preferably from 60 Shore D to 90 Shore D.

The security document S may have any shape that a person skilled in the art would select for a security document S. It is preferable for the security document S to have a sheetlike extent in the form of a square, a rectangle, a circle, an oval or a polyhedron, more preferably in the form of a square or a rectangle.

The security document S preferably has a thickness in a range from 40 to 250 μm, more preferably in a range from 50 to 200 μm, more preferably still in a range from 60 to 150 μm, very preferably in a range from 70 to 100 μm.

The aspect ratio between the thickness of the security document S and its area is preferably in a range from 1:100 000 to 1:1000, more preferably in a range from 1:50 000 to 1:500, more preferably still in a range from 1:10 000 to 1:100.

The first polymer film A1 preferably has a thickness in a range from 10 to 100 μm, more preferably in a range from 12 to 90 μm, more preferably in a range from 15 to 50 μm, more preferably in a range from 20 to 40 μm.

The optional second polymer film A2 preferably has a thickness in a range from 20 to 150 μm, more preferably in a range from 30 to 100 μm, more preferably in a range from 40 to 90 μm, more preferably in a range from 50 to 80 μm.

The optional at least one further polymer film A3 preferably has a thickness in a range from 10 to 100 μm, more preferably in a range from 12 to 90 μm, more preferably in a range from 15 to 50 μm, more preferably in a range from 20 to 40 μm.

At least one polymer film selected from the group consisting of the first polymer film A1, A2 and A3 in each case preferably has a length in a range from 1 to 100 cm, more preferably in a range from 2 to 80 cm, more preferably still in a range from 5 to 50 cm. Preferably, all polymer films selected from the group consisting of the first polymer film A1, A2 and optionally A3 have a length that does not deviate more than 10%, based on the longest polymer film. More preferably, all polymer films A1, A2 and A3 have the same length.

At least one polymer film selected from the group consisting of the first polymer film A1, A2 and A3 in each case preferably has a width in a range from 1 to 100 cm, more preferably in a range from 2 to 80 cm, more preferably still in a range from 5 to 50 cm. Preferably, all polymer films selected from the group consisting of the first polymer film A1, A2 and optionally A3 have a length that does not deviate more than 10%, based on the longest polymer film. More preferably still, all polymer films A1, A2 and A3 have the same width.

It is preferable for the polymer films A1 and A2 and preferably also A3 to be congruent in their direction of areal extent.

The security document S is preferably selected from the group consisting of a banknote, a birth certificate, a postage stamp, a tax stamp, a visa page of a passport, a hinge for the data page of a passport, a carrier layer of an electromagnetic shielding in a passport, or a combination of at least two of these.

The outer side AS1 is formed by the polymer film A1. The outer side AS2 can be formed of different polymer films, selected from polymer film A1, polymer film A2 or polymer film A3 or a combination of at least two of them. If the structure is a monofilm, the first polymer film A1 forms both the outer sides AS1 and AS2.

The security document S preferably further comprises security features A5 selected from the group consisting of a hologram, a security thread, a fluorescent fiber, a dye, a security pigment, carbon black, metallic or non-metallic micro- or nanoparticles, magnetic particles, an embossing or a combination of at least two of these.

In a preferred embodiment, the security document S comprises the second polymer film A2. Preferably, the second polymer film A2 is in direct contact with the first polymer film A1. Preferably, the first polymer film comprises a thermoplastic polyurethane TPU having a hardness in a range from 80 Shore A to 95 Shore D, preferably from 85 Shore A to 90 Shore D, more preferably from 90 Shore A to 85 Shore D, very preferably from 95 Shore A to 80 Shore D, most preferably from 60 Shore D to 80 Shore D to an extent of at least 50% by weight, and the second polymer film A2 comprises a thermoplastic polyurethane TPU having a hardness in a range from 60 Shore D to 95 Shore D, preferably from 65 Shore D to 90 Shore D, more preferably from 70 Shore D to 85 Shore D to an extent of at least 50% by weight.

In a preferred embodiment of the security document S, the print layer A4 consists of printing inks selected from the group consisting of offset printing inks, flexo printing inks, screen printing inks, digital printing inks, inks for intaglio printing or a combination thereof. The printing inks are preferably UV-curing inks or oxidatively curing inks. Preferably, the print layer A4 is applied by the printing method to the first polymer film A1 with a nominal line width in a range from 10 to 500 μm, from 20 μm to 400 μm, preferably from 50 to 350 μm, more preferably from 100 to 300 μm. The printed line width preferably does not deviate from the nominal line width by more than 2 to 20 μm. Preferably, the line width in its course has a width variance of 1 to 20 μm, preferably of 2 to 15 μm, more preferably of 3 to 10 μm. Even intersecting lines together have a width variance of 2 to 30 μm, preferably of 4 to 20 μm, more preferably of 5 to 15 μm.

In a preferred embodiment of the security document S, the print layer A4 has at least one, preferably at least two, more preferably at least three of the following properties:
(D1) that it consists of at least one line, the at least one line having a shape selected from the group consisting of a circle, a polygon, an oval, a polygon or a combination of at least two of them;
(D2) that it has a line width of 20 μm to 500 μm, preferably from 50 to 400 μm, more preferably from 100 to 300 μm;
(D3) that at least one line of the print layer A4 is configured with a deviation from the nominal line width in a range from 2 to 20 μm, preferably from 3 to 15 μm, more preferably from 4 to 10 μm;
(D4) has a height in a range from 0.5 μm to 15 μm;
(D5) an increased abrasion resistance;
(D6) that it is formed of a dye selected from the group consisting of a powder, a printing paste;
(D7) that at least one part of it is black;
(D8) that at least one part of it is colored.

In a preferred embodiment of the security document S, at least one of the polymer films A1, A2 or optionally A3, preferably the entire security document S, has at least one of the following properties:
a. a tear resistance in a range from 50 N/mm to 400 N/mm, more preferably from 60 N/mm to 350 N/mm, more preferably still from 70 N/mm to 300 N/mm, determined according to DIN 53363:2003-10;
b. a tensile strength in a range from 20 MPa to 200 MPa, more preferably from 25 MPa to 170 MPa, more preferably still from 30 MPa to 150 MPa, determined according to ISO 527-3:1995;
c. a luminous transmittance in a range from 0% to 85%, preferably from 1% to 50%, more preferably from 5% to 30%, determined according to ISO 13468-2:2019;
d. a crease recovery angle in a range from 120 to 170°, more preferably from 130 to 160°, more preferably still from 140 to 1500 according to DIN 53890/91;
e. a Vicat softening temperature of 60 °C to 105 °C, more preferably of 65 °C to 85 °C, according to DIN EN ISO 306;
f. a surface tension of 32 to 55 mN/m according to DTN ISO 8296:2003.

Preferably, the security document S has the properties or property combinations selected from the group consisting of a., b., c., d., e., f., a.+b., a.+c., a+d., a.+e., a.+f., b.+c., b.+d., b.+e., b.+f., c.+d., c.+e., c.+f., d.+e., d.+f., a.+b.+c., a.+b.+d., a.+b.+e., a.+b.+f., a.+c.+d., a.+c.+e., a.+c.+f., a.+d.+e., a.+d.+f., a.+e.+f., b.+c.+d., b.+c.+e., b.+c.+f., b.+d.+e., b.+d.+f., b.+e.+f., c.+d.+e., c.+d.+f., c.+e.+f., d.+e.+f., a.+b.+c.+d., a.+b.+c.+e., a.+b.+c.+f., a.+b.+d.+e., a.+b.+d.+f., a.+b.+e.+f., a.+c.+d.+e., a.+c.+d.+f., a.+c.+e.+f., a.+d.+e.+f., b.+c.+d.+e., b.+c.+d.+f., b.+d.+e.+f., c.+d.+e.+f., a.+b.+c.+d.+e., a.+b.+c.+d.+f., a.+b.+c.+e.+f., a.+b.+d.+e.+f., a.+c.+d.+e.+f., b.+c.+d.+e.+f., a.+b.+c.+d.+e.+f. It is especially preferable for the security document S to have the properties a. and f.

It is preferable for the polymer films A1, A2 and/or optionally A3 to further comprise a UV stabilizer as an additive. It is preferable for the polymer films A1, A2 and/or A3 to comprise the UV stabilizer in an amount in a range from 0.1% to 15% by weight, more preferably in a range from 1% to 10% by weight, more preferably still in a range from 2% to 7% by weight, based on the total weight of the respective polymer film A1, A2 or A3. The UV stabilizers are preferably commercially available products such as Tinuvin®P from BASF AG (Germany).

In the case of a multilayer film, the outer side AS2, which is formed not by the polymer film A1 but by the polymer film A2 or optionally a polymer film A3, preferably comprises a thermoplastic elastomer (TPE) selected from the group consisting of a copolyester elastomer (TPC), a thermoplastic polyamide elastomer (TPA), in particular a polyether-block-amide (PEBA), an olefin-based thermoplastic elastomer (TPO), in particular PP/EPDM, a thermoplastic polyurethane (TPU), a thermoplastic polycarbonate (PC), apolyethylene terephthalate (PET), in particular a polyethylene terephthalate glycol (PETG), a thermoplastic styrene block copolymer (TPS), in particular styrene-butadiene block copolymer (SBC), or a mixture of at least two of these. TPEs are elastomers which behave like classical representatives of elastomers at room temperature but become deformable upon heating. These are usually copolymers composed of a soft elastomer component and a hard thermoplastic component.

Suitable copolyester elastomers TPC (segmented polyester elastomers), hereinafter also referred to simply as copolyesters, are formed for example from a plurality of repeating short-chain ester units and long-chain ester units joined by ester bonds, wherein the short-chain ester units account for about 15-80% by weight of a copolyester and conform to formula (I):

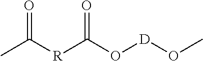

in which
R is a divalent radical of a dicarboxylic acid which has a molecular weight of less than about 350 g/mol,
D is a divalent organic diol radical which has a molecular weight of less than about 250 g/mol; the long-chain ester units account for about 20% to 85% by weight, preferably 30% to 70% by weight, particularly preferably 35% to 60% by weight, of the copolyester and preferably conform to formula II:

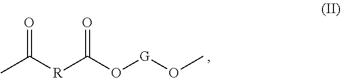

in which
R is a divalent radical of a dicarboxylic acid which has a molecular weight of less than about 350 g/mol,
G is a divalent radical of a long-chain glycol which has an average molecular weight of about 350 to 6000 g/mol.

The employable copolyesters may be produced by copolymerizing a) one or more dicarboxylic acids, b) one or more linear, long-chain glycols and c) one or more low molecular weight diols.

The dicarboxylic acids for the production of the copolyester are aromatic acids having 8-16 carbon atoms, in particular phenylenedicarboxylic acids such as phthalic, terephthalic and isophthalic acid.

The low molecular weight diols for the reaction to form the short-chain ester units of the copolyesters belong to the classes of the acyclic, alicyclic and aromatic dihydroxy compounds. The preferred diols have 2-15 carbon atoms, such as ethylene, propylene, tetramethylene, isobutylene, pentamethylene, 2,2-dimethyltrimethylene, hexamethylene and decamethylene glycols, dihydroxycyclohexane, cyclohexanedimethanol, resorcinol, hydroquinone and the like. Bisphenols for the present purpose include bis(p-hydroxy)diphenyl, bis(p-hydroxyphenyl)methane, bis(p-hydroxyphenyl)ethane and bis(p-hydroxyphenyl)propane.

The long-chain glycols used to produce the soft segments of the copolyesters preferably have molecular weights of about 600 to 3000 g/mol. These include poly(alkylene ether) glycols in which the alkylene groups have 2-9 carbon atoms.

Glycol esters of poly(alkylene oxide)dicarboxylic acids or polyester glycols can also be used as long-chain glycol.

The long-chain glycols also include polyformals, which are obtained by reacting formaldehyde with glycols. Polythioether glycols are also suitable. Polybutadiene glycols and polyisoprene glycols, copolymers of the same, and saturated hydrogenation products of these materials are satisfactory long-chain polymeric glycols.

Processes for synthesizing such copolyesters are known from DE-A 2 239 271, DE-A 2 213 128, DE-A 2 449 343 and U.S. Pat. No. 3,023,192. Examples of suitable TPCs are polyether elastomers Hytrel® from DuPont™ (Germany) and polyether elastomers Keyflex® from LG Chemicals (Europe), preferably representatives thereof having a hardness in the range from 80 Shore A to 95 Shore D.

The thermoplastic polyamide elastomer (TPA) may be any TPA that a person skilled in the art would select for this purpose. The TPA is preferably a polyether block amide (PEBA). Suitable PEBAs are for example those consisting of polymer chains formed from repeating units conforming to formula (III)

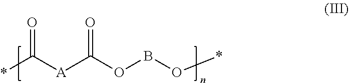

in which
A is the polyamide chain derived from a polyamide having 2 carboxyl end groups via the loss of the latter and
B is the polyoxyalkylene glycol chain derived from a polyoxyalkylene glycol having terminal OH groups via the loss of the latter, and
n is the number of units forming the polymer chain. The end groups here are preferably OH groups or radicals of compounds which terminate the polymerization.

The dicarboxylic polyamides having the terminal carboxyl groups are obtained in a known manner, for example by polycondensation of one or more lactams and/or one or more amino acids, or else by polycondensation of a dicarboxylic acid with a diamine, in each case in the presence of an excess of an organic dicarboxylic acid preferably having terminal carboxyl groups. These carboxylic acids become constituents of the polyamide chain during the polycondensation and undergo addition especially onto the ends of said chain, thus affording a polyamide having μ-dicarboxylic acid functionality. The dicarboxylic acid also acts as a chain terminator, which is why it is also used in excess.

The polyamide can be obtained from lactams and/or amino acids having a hydrocarbon chain consisting of 4-14 carbon atoms, for example from caprolactam, enantholactam, dodecalactam, undecanolactam, decanolactam, 11-aminoundecanoic or 12-aminododecanoic acid.

Examples of polyamides such as are formed by polycondensation of a dicarboxylic acid with a diamine include the condensation products of hexamethylenediamine with adipic acid, azelaic acid, sebacic acid and 1,12-dodecanedioic acid, and the condensation products of nonamethylenediamine and adipic acid, preferably representatives thereof having a hardness in the range from 80 Shore A to 95 Shore D.

Suitable dicarboxylic acids for the synthesis of the polyamide, employed both for fixing one carboxyl group to each end of the polyamide chain and as chain terminator, include those having 4-20 carbon atoms, in particular alkanedioic acids, such as succinic acid, adipic acid, suberic acid, azelaic acid, sebacic acid, undecanedioic acid or dodecanedioic acid, and additionally cycloaliphatic or aromatic dicarboxylic acids such as terephthalic acid or isophthalic acid or cyclohexane-1,4-dicarboxylic acid.

The polyoxyalkylene glycols having terminal OH groups are unbranched or branched and comprise an alkylene radical having at least 2 carbon atoms. These are preferably polyoxyethylene, polyoxypropylene and polyoxytetramethylene glycol, as well as copolymers thereof.

The average molecular weight of these OH group-terminated polyoxyalkylene glycols may vary over a wide range and is advantageously between 100 and 6000 g/mol, in particular between 200 and 3000 g/mol.

The weight fraction of the polyoxyalkylene glycol, based on the total weight of the polyoxyalkylene glycol and dicarboxylic polyamide used to produce the PEBA polymer, is 5-85% by weight, preferably 10-50% by weight.

Processes for synthesizing such PEBA polymers are known from FR Patent 7 418 913, DE-A 28 02 989, DE-A 28 37 687, DE-A 25 23 991, EP-A 095 893, DE-A 27 12 987 and DE-A 27 16 004.

PEBA polymers which, in contrast to those described above, have a random structure are preferentially suitable. To produce these polymers a mixture of:
1. one or more polyamide-forming compounds from the group of aminocarboxylic acids or lactams having at least 10 carbon atoms,
2. an α,ω-dihydroxypolyoxyalkylene glycol,
3. at least one organic dicarboxylic acid

in a 1:(2+3) weight ratio of between 30:70 and 98:2, wherein hydroxyl groups and carbonyl groups are present in equivalent amounts in (2+3), is heated to temperatures of between 23 °C and 30 °C in the presence of 2% to 30% by weight of water based on the polyamide-forming compounds of group 1. under autogenous pressure and subsequently after removal of the water subjected to further treatment at 250 °C to 280 °C at standard pressure or under reduced pressure in the absence of oxygen.

The TPO may be any TPO that a person skilled in the art would select for a security document S according to the invention. Examples of TPO are thermoplastic olefins of the product line KEYFLEX® from LG Chemicals (Europe), such as KEYFFLEX® TP-1045D. The TPO is preferably a PP/EPDM. Examples of these TPO types are Santoprene™ from Advanced Elastomer Systems Ltd., a subsidiary of ExxonMobil Chemical Europe (Belgium), Saxomer® TPE-O from PCW GmbH (Germany), Elastron TPO from Elastron (Turkey/Germany), preferably representatives thereof having a hardness in the range from 80 Shore A to 95 Shore D.

The thermoplastic polyurethane (TPU) may be any TPU that a person skilled in the art would select for the security document S according to the invention.

A preferred process for producing thermoplastically processable polyurethane polymers is one that comprises reacting the components
(A) one or more substantially linear polyols, wherein the total amount of component (A) has an average molecular weight in the range from 500 g/mol to 5000 g/mol,
(B) one or more organic polyisocyanates, preferably organic diisocyanates,
(C) one or more linear diols having a molecular weight of 62 g/mol to 500 g/mol,
(D) optionally in the presence of one or more catalysts,
(E) optionally in the presence of one or more additives, auxiliary and/or additive substances and
(F) optionally in the presence of one or more monofunctional chain terminators,

wherein the process preferably comprises or consists of the following steps:
1) providing and reacting a mixture composed of the total amount of component (A), a subamount of component (B) and optionally a subamount or the total amount of component (D), component (E) and/or component (F) to afford an NCO-functional prepolymer, wherein in process step 1) a molar ratio of component (B) to component (A) is in the range from 1.1:1.0 to 5.0:1.0,
2) reacting the NCO-functional prepolymer from process step 1) with the total amount of component (C) to obtain an OH-functional prepolymer, optionally in the presence of a further subamount of component (D), component (E) and/or component (F),
3) reacting the OH-functional prepolymer with the remaining amount of component (B) and any remaining amount of component (D), component (E) and/or component (F) to obtain the thermoplastically processable polyurethane, wherein over all process steps a molar ratio of component (B) to the sum of component (A) and component (C) is in the range from 0.9:1.0 to 1.2:1.0.

The preferred process makes it possible to produce thermoplastic polyurethanes having good processing properties and good mechanical properties over a hardness range from about 80 Shore A to about 95 Shore D while achieving good coupling of the hard and soft phases of the TPU, resulting in an optimally high molecular weight and thus in very good mechanical properties of the manufactured workpieces.

The word “a” in the context of the present invention in connection with countable parameters is to be understood as meaning the number “one” only when this is stated explicitly (for instance by the expression “precisely one”). When reference is made hereinbelow for example to “a polyol”, the word “a” is to be understood as meaning merely the indefinite article and not the number “one”; this therefore also encompasses an embodiment comprising a mixture of at least two polyols.

“Substantially” in this context means that at least 95 mol %, preferably at least 98 mol %, more preferably at least 99 mol % and yet more preferably at least 99.5 mol %, yet more preferably at least 99.8 mol % and most preferably 100 mol % of the total amount of substance of the polyols of component A) consists of linear polyols.

The hardness of the thermoplastically processable polyurethanes can be adjusted from 80 Shore A to 95 Shore D by selecting the molar ratio of component (A) to component (C).

The amounts of the reaction components for the NCO-functional prepolymer formation in step 1) are selected such that the NCO/OH ratio of polyisocyanate to polyol in step 1) is from 1.1:1 to 5.0:1.

The components are intimately mixed and the NCO prepolymer reaction in step 1) is preferably brought to complete conversion (based on the polyol component).

This is followed by incorporation of at least component (C) as chain extender (step 2) to afford a substantially OH-functional prepolymer.

Subsequently, in step 3), the residual amount of component (B) is added while maintaining an NCO/OH ratio of 0.9:1 to 1.2:1. It is preferable when step 3) employs the same component (B) as step 1).

It is preferable when process step 2) is carried out with a molar ratio of NCO-functional prepolymer to component (C) of less than 1.0. Component (C) is thus present in a molar excess.

Suitable components (A) include all linear polyols known to those skilled in the art and having an average molecular weight of greater than 500 g/mol. Suitable components (A) especially include the following linear polyols: a) polyester polyols, b) polyether polyols, c) polyether esters, d) polycarbonate polyols, e) polyether carbonates, or mixtures of at least two of the polyols a) to e).

Suitable polyester diols a) can be prepared, for example, from dicarboxylic acids having 2 to 12 carbon atoms, preferably 2 to 6 carbon atoms, and polyhydric alcohols. Examples of useful dicarboxylic acids include: aliphatic dicarboxylic acids such as succinic acid, glutaric acid, adipic acid, suberic acid, azelaic acid and sebacic acid, dodecanedioic acid and aromatic dicarboxylic acids such as phthalic acid, isophthalic acid and terephthalic acid. The dicarboxylic acids may be used individually or as mixtures, for example in the form of a succinic, glutaric and adipic acid mixture. For production of the polyester polyols it may in some cases be advantageous to use the corresponding dicarboxylic acid derivatives, such as carboxylic diesters having 1 to 4 carbon atoms in the alcohol radical, carboxylic anhydrides or carbonyl chlorides instead of the dicarboxylic acids. Examples of polyhydric alcohols are glycols having 2 to 12 and preferably 2 to 6 carbon atoms, such as ethylene glycol, diethylene glycol, butane-1,4-diol, pentane-1,5-diol, hexane-1,6-diol, decane-1,10-diol, dodecane-1,12-diol, 2,2-dimethylpropane-1,3-diol, propane-1,3-diol, propane-1,2-diol and dipropylene glycol. Depending on the desired properties, the polyhydric alcohols may be used alone or optionally in a mixture with one another. Also suitable are condensation products of hydroxycarboxylic acids, for example hydroxycaproic acid, and polymerization products of lactones, for example optionally substituted caprolactones. Polyester polyols used with preference are ethanediol polyadipates, butane-1,4-diol polyadipates, hexane-1,6-diol polyadipates, ethanediol butane-1,4-diol polyadipates, hexane-1,6-diol neopentyl glycol polyadipates, hexane-1,6-diol butane-1,4-diol polyadipates and polycaprolactones. The polyester diols have molecular weights in the range from 500 to 5000 g/mol, preferably in the range from 600 to 3500 g/mol and particularly preferably in the range from 800 to 3000 g/mol. They may be used individually or in the form of mixtures with one another.

Suitable polyether diols b) may be prepared by reacting one or more alkylene oxides having 2 to 4 carbon atoms in the alkylene radical with a starter molecule containing two active hydrogen atoms in bonded form. Examples of alkylene oxides include: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides may be used individually, alternately in succession or as mixtures. Examples of starter molecules contemplated include: water, amino alcohols, such as N-alkyldiethanolamines, for example N-methyldiethanolamine, and diols, such as ethylene glycol, 1,3-propylene glycol, butane-1,4-diol and hexane-1,6-diol. It is optionally also possible to use mixtures of starter molecules. Suitable polyether diols are, additionally, the hydroxyl group-containing polymerization products of tetrahydrofuran. It is also possible to use trifunctional polyethers in proportions of 0 to 30% by weight based on the bifunctional polyethers but at most in an amount such that a thermoplastically processable product is formed. Suitable polyether diols have a number-average molecular weight M. of 500 to 5000 g/mol, preferably 750 to 5000 g/mol and very particularly preferably 900 to 4200 g/mol. They may be used either individually or else in the form of mixtures with one another.

Suitable polyether esters c) may be prepared for example by reaction of short-chain polyether diols, for example polytetrahydrofurans having molecular weights of 250 to 1000 g/mol, with organic dicarboxylic acids, for example succinic acid or adipic acid. The polyether ester diols have molecular weights of 600 to 5000 g/mol, preferably 700 to 4000 g/mol and particularly preferably 800 to 3000 g/mol. They may be used individually or in the form of mixtures with one another.

Suitable polycarbonate diols d) may be prepared for example by reaction of short-chain diols, for example butane-1,4-diol or hexane-1,6-diol, with diphenyl carbonate or dimethyl carbonate with the assistance of catalysts and with elimination of phenol or methanol. The polycarbonate diols have a number-average molecular weight of from 500 to 5000 g/mol, preferably from 750 to 5000 g/mol and particularly preferably from 1000 to 4500 g/mol.

Suitable polyether carbonate diols e) can be prepared, for example, by reaction of short-chain polyether diols such as polytetrahydrofurans having molecular weights of 250 to 1000 g/mol with diphenyl or dimethyl carbonate with the assistance of catalysts and with elimination of phenol or methanol. Polyether carbonate diols may moreover be prepared by copolymerization of alkylene oxides, e.g. ethylene oxide or propylene oxide or mixtures thereof, with carbon dioxide with the assistance of suitable catalysts, e.g. double metal cyanide catalysts. The polyether carbonate diols have a number-average molecular weight of 500 to 8000 g/mol, preferably 750 to 6000 g/mol and more preferably 1000 to 4500 g/mol.

Preferred organic polyisocyanates of component (B) which are employed in steps 1) and 3) are aliphatic, cycloaliphatic, araliphatic, heterocyclic and aromatic polyisocyanates, such as are described in Justus Liebigs Annalen der Chemie, 562, p. 75-136.

Specific examples include for example: aliphatic diisocyanates, such as 1,6-hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanato-1,2-diphenylethane and 1,5-naphthylene diisocyanate. Preferably employed are 1,6-hexamethylene diisocyanate, isophorone diisocyanate, 4,4′-dicyclohexylmethane diisocyanate, diphenylmethane diisocyanate isomer mixtures having a 4,4′-diphenylmethane diisocyanate content of >96% by weight and especially 4,4′-diphenylmethane diisocyanate and 1,5-naphthylene diisocyanate. These diisocyanates may be used individually or in the form of mixtures with one another. They may also be used together with up to 15% by weight (based on the total amount of diisocyanate) of a polyisocyanate, for example triphenylmethane 4,4′,4″-triisocyanate or polyphenylpolymethylene polyisocyanates.

It is preferable when component (B) employed is a diphenylmethane diisocyanate isomer mixture having a 4,4′-diphenylmethane diisocyanate content of more than 96% by weight based on the total weight of component (B); preferably, component (B) is 4,4′-diphenylmethane diisocyanate.

Component (B) employed is preferably 1,6-hexamethylene diisocyanate.

Suitable components (C) (chain extender) include all linear diols known to those skilled in the art and having a molecular weight of 62 g/mol to 500 g/mol. The diols and/or their precursor compounds may have been obtained from fossil or biological sources. Suitable diols are preferably aliphatic diols having 2 to 14 carbon atoms, such as for example ethanediol, butane-1,4-diol, hexane-1,6-diol, octane-1,8-diol, decane-1,10-diol, dodecane-1,12-diol, diethylene glycol and dipropylene glycol. However, also suitable are diesters of terephthalic acid with glycols having 2 to 4 carbon atoms, such as for example terephthalic acid bis-ethylene glycol or terephthalic acid bis-butane-1,4-diol, hydroxyalkylene ethers of hydroquinone, such as for example 1,4-di(hydroxyethyl)hydroquinone and ethoxylated bisphenols. Particular preference is given to using ethanediol, butane-1,4-diol, hexane-1,6-diol and 1,4-di(hydroxyethyl)hydroquinone as short-chain diols. Mixtures of the abovementioned chain extenders may also be used. It is also possible to add small quantities of diamines and/or triols.

It is preferable when component (C) employed is or more diols selected from the group consisting of ethane-1,2-diol, butane-1,4-diol, hexane-1,6-diol, 1,4-di(beta-hydroxyethyl)hydroquinone or a mixture of at least two of these; preferably, component (C) employed is ethane-1,2-diol, butane-1,4-diol or mixtures thereof and particularly preferably ethane-1,2-diol.

Catalysts (D) that may be used include the customary catalysts known from polyurethane chemistry. Suitable catalysts include customary tertiary amines known per se, for example triethylamine, dimethylcyclohexylamine, N-methylmorpholine, N,N′-dimethylpiperazine, 2-(dimethylaminoethoxy)ethanol, diazabicyclo[2.2.2]octane and the like and especially also organometallic compounds such as titanate esters, iron compounds, bismuth compounds, tin compounds, for example tin diacetate, tin dioctoate, tin dilaurate or the dialkyltin salts of aliphatic carboxylic acids such as dibutyltin diacetate, dibutyltin dilaurate or the like. Preferred catalysts are organometallic compounds, in particular titanate esters, iron compounds or tin compounds. Very particular preference is given to dibutyltin dilaurate, tin dioctoate and titanate esters.

Further details and preferred embodiments of the production process for suitable TPUs may be found in EP 3 838 961 A.

It is preferable when the TPE comprises a thermoplastic polyurethane (TPU), preferably produced by the above-described process, in a range from 10% to 100% by weight, more preferably in a range from 20% to 95% by weight, more preferably in a range from 30% to 90% by weight, particularly preferably in a range from 40% to 85% by weight, based on the total weight of the TPE.

The polymer film A2 preferably comprises a TPU having a hardness in a range from 40 to 95 Shore D, preferably in a range from 55 to 90 Shore D, very preferably from 60 to 85 Shore D. The polymer film A2 preferably comprises the TPU, preferably produced by the above-described process, in a range from 10% to 100% by weight, more preferably in a range from 20% to 95% by weight, based on the total weight of the polymer film A2.

Examples of types of TPU suitable both for polymer film A1 and for polymer film A2 are: Estane® from Lubrizol, Elastollan® from BASF AG (Germany), Desmopan® from Covestro Deutschland AG (Germany), preferably those having a hardness of 80 Shore A to 95 Shore D.

The thermoplastic polycarbonate (PC) may be any elastomeric PC that a person skilled in the art would select for this purpose. The PC is preferably produced according to the polycarbonates described in WO 2018/11436 A1, in particular the polycarbonate blends such as are described on page 3, last paragraph to page 16, third paragraph.

The polyethylene terephthalate (PET) may be any PET that a person skilled in the art would employ for the security document S according to the invention. The PET is preferably a polyethylene terephthalate glycol (PETG), for example Eastar® from EASTMAN Chemical GmbH (Germany).

The thermoplastic styrene block copolymer (TPS) may be any styrene block copolymer that a person skilled in the art would employ for the security document S according to the invention. Preferred TPS are styrene-ethylene-butylene-styrene block copolymer (SEBS), styrene-ethylene-propylene-styrene block copolymer (SEPS), styrene-isoprene-styrene block copolymer (SIS), styrene-ethylene-butadiene-styrene (SEEPS) and methyl methacrylate-butadiene-styrene (MBS). Examples of SBS product lines include Styroflex® from BASF AG (Germany) and THERMOLAST® from Kraiburg Holding (Germany). Examples of SBES product lines include Saxomer® TPE-S from PCW GmbH (Germany), preferably representatives thereof having a hardness of 40 to 95 Shore D.

The TPE preferably contains the additives customary for plastics. Examples of typical additives are lubricants, such as fatty acid esters, metal soaps thereof, fatty acid amides and silicone compounds, antiblocking agents, inhibitors, stabilizers against hydrolysis, light, heat and discoloration, flame retardants, dyes, pigments, inorganic or organic fillers, and reinforcers. Further information about the recited auxiliary and additive substances may be found in the specialist literature, for example J. H. Saunders, K. C. Frisch: “High Polymers”, volume XVI, Polyurethane, part 1 and 2, Interscience Publishers 1962 and 1964, R. Gächter, H. Müller (Ed.): Taschenbuch der Kunststoff-Additive, 3rd edition, Hanser Verlag, Munich 1989, or DE-A 29 01 774.

Preferably, both outer sides AS1 and AS2 of the security document S comprise a TPU. Both outer sides AS1 and AS2 preferably consist of a TPU. Preferably, one outer side AS1 of the security document S is formed by the first polymer film AS1 and the other outer side AS2 by a further polymer film A3, wherein the two polymer films A1 and A3 preferably have the same composition. Further preferably, the polymer film A2 forms the core of the security document S, in the form of an at least three-layer structure in which the outer sides AS1 and AS2 each consist of the same material. Further preferably, in the at least three-layer structure in which the polymer layer A2 forms the core layer, the polymer layer A2 comprises a harder TPU than the outer sides AS1 and AS2, which are formed from the polymer layers A1 and A3.

Alternatively, the security document S may have an at least three-layer structure which as the core layer has a softer TPU layer in the form of the polymer layer A2 than the polymer layers A1 and A3 which form the outer sides AS1 and AS2.

It is preferable for at least one of the polymer films A1, A2 and optionally A3, in particular the first polymer film A1, to comprise a material which is suitable for developing a peel adhesion to the respective adjacent polymer film, i.e. the second polymer film A2 or the further polymer film A3, which is greater than the elongation at break of at least one of the polymer films A1, A2 or A3. The peel adhesion is higher than the breaking stress of the respective polymer film when one of the polymer films A1, A2 or A3 cannot be separated with no residue from the respective adjacent polymer film. This means that on separation of the first polymer film A1 from the second polymer film A2 or optionally of the second polymer film A2 from the further polymer film A3, at least one of the polymer films A1, A2 or A3 suffers a cohesive failure and not an adhesive failure where the peel adhesion would be less than the breaking stress of the polymer films. In contrast to an adhesive failure, which would represent a parting of the security document S at the adhesive surface between the respective films and would allow residueless separation of the films from one another, cohesive failure occurs inside the layer and leaves residues of the polymer material on the respective other film that is to be separated.

This sufficiently high adhesion force thus contributes to the forgery resistance of the security document S.

It is preferable for the polymer films A1, A2 and optionally A3 to have an adhesive strength to their respectively adjacent polymer film of at least 2 N/cm, more preferably of at least 3 N/cm, particularly preferably of at least 5 N/cm. It is preferable for the polymer films A1, A2 and optionally A3 to have an adhesive strength to their respectively adjacent polymer film in a range from 2 to 20 N/cm, more preferably from at least 3 N/cm to 15 N/cm, particularly preferably from at least 5 N/cm to 10 N/cm, measured according to ASTM D903-1998 at a tensile angle of 180°.

In a preferred embodiment of the security document S, the outer sides AS1 and AS2 of the security document S consist of a polymer film A1, A2 or A3 comprising or consisting of a TPU.

In a preferred embodiment of the security document S, all polymer films A1, A2 and optionally A3 consist exclusively of polymers. Preferably, all polymer films A1, A2 and optionally A3 consist of a TPE, wherein at least the polymer film A1 comprises a TPU to an extent of at least 50% by weight. It is very preferable for all polymer films A1, A2 and optionally A3 to consist of a mutually independently selected TPU. It is preferable for the complete security document S to consist of polymers with the exception of the print layer A4 and the optional security feature A5.

In a preferred embodiment of the security document S, at least one of the polymer films selected from the group consisting of the second polymer film A2, the further polymer film A3 or both comprises the TPE in an amount in a range from 50% to 100% by weight, preferably from 60% to 90% by weight, more preferably from 70% to 80% by weight, based on the total weight of the respective polymer film A2 or A3. It is particularly preferable for the polymer films A2 and A3 to consist of a TPE. It is particularly preferable for the polymer films A2 and A3 to consist of a TPU.

In a preferred embodiment of the security document S, the security document S comprises at least one second polymer film A2, wherein the at least one second polymer film A2 comprises a thermoplastic elastomer TPE in an amount in a range from 50% to 100% by weight, preferably from 60% to 90% by weight, more preferably from 70% to 80% by weight, based on the total weight of the respective polymer film A2.

With preference, at least one of the polymer films selected from the group consisting of the second polymer film A2, the further polymer film A3 or both polymer films A2 and A3 comprises a polymer selected from the group consisting of a thermoplastic polyurethane (TPU), a copolyester or a mixture of at least two of these or mixtures of TPU and further TPEs in an amount in a range from 50% to 100% by weight, preferably from 60% to 90% by weight, more preferably from 70% to 80% by weight, based on the total weight of the respective polymer film A2 or A3.

With preference, the security document S comprises at least one further polymer film A3, wherein the at least one further polymer film A3 comprises the TPE in an amount in a range from 50% to 100% by weight, preferably from 60% to 90% by weight, more preferably from 70% to 80% by weight, based on the total weight of the respective polymer film A3. It is particularly preferable for the at least one further polymer film A3 to consist of a TPE. It is very preferable for the at least one polymer film A3 to consist of a TPU.

It is preferable for the at least one further polymer film A3 to have the same composition as the polymer film A1 or A2. It is very preferable for all three polymer films A1, A2 and A3 to comprise a TPE to an extent of at least 50% by weight, preferably to an extent of at least 80% by weight, more preferably to an extent of 100% by weight, wherein the TPE is preferably one of the abovementioned TPEs, more preferably at least one TPU. It is particularly preferable for the further polymer film A3 to have the same composition as the first polymer film A1.

In a preferred embodiment of the security document S, the thermoplastic elastomer TPE is selected from the group consisting of a thermoplastic polyamide elastomer, an olefin-based thermoplastic elastomer, preferably PP/EPDM, a thermoplastic styrene block copolymer SBS, SEBS, SEPS, SEEPS and MBS, a thermoplastic polyurethane TPU, a copolyester elastomer, a polyether-block-amide, a copolyester, a polycarbonate, a polyethylene terephthalate PET, a polyethylene terephthalate glycol PETG or a mixture of at least two of these.

In a preferred embodiment of the security document S, all polymer films A1, A2 and optionally A3 comprise a polymer in an amount in a range from 50% to 100% by weight, preferably from 60% to 90% by weight, more preferably from 70% to 80% by weight, based on the total weight of the respective polymer film A1, A2 or A3.

In a preferred embodiment of the security document S, one of the polymer films selected from the group consisting of the second polymer film A2 or the at least one further polymer film A3 comprises a polymer selected from the group consisting of a thermoplastic polyurethane TPU, a copolyester or a mixture of at least two of these or mixtures of TPU and at least one further TPE in an amount in a range from 50% to 100% by weight, preferably from 60% to 90% by weight, more preferably from 70% to 80% by weight, based on the total weight of the respective polymer film A2 or A3.

In a preferred embodiment of the security document S, the security document S has at least one of the following properties:
a. a tear resistance in a range from 50 N/mm to 400 N/mm determined according to DIN 53363:2003-10;
b. a tensile strength in a range from 20 MPa to 200 MPa determined according to ISO 527-3:1995;
c. a luminous transmittance in a range from 0% to 85%, determined according to ISO 13468-2:2019;
d. a content of security pigments in a range from 0.1% to 10% by weight, based on the total weight of the security document S;
e. a crease recovery angle in a range from 120 to 170°, more preferably from 130 to 160°, more preferably still from 140 to 1500 according to DIN 53890/91;
f. a surface tension of 32 to 55 mN/m according to DIN ISO 8296:2003.

A further aspect of the invention relates to a process for producing a security document S having a first outer side AS1 and a second outer side AS2 opposite the first outer side AS1, comprising the steps of
i) providing a first polymer A1′, wherein the first polymer A1′ comprises at least one TPU having a hardness in a range from 80 Shore A to 95 Shore D, preferably from 60 Shore D to 90 Shore D, in an amount of 50% to 100% by weight, based on the total weight of the polymer A1′;
ii) optionally providing a second polymer A2′;
iii) optionally providing a further polymer A3′;
iv) melting the polymers from step i), optionally ii) and optionally iii);
v) either forming a first polymer film as an extrudate from the melt of the polymer A1′ from step iv), or merging the polymer melts from step iv) to form a first polymer film A1 from the first polymer A1′, a second polymer film A2 from the second polymer A2′ and optionally a further polymer film A3 from the further polymer A3′ as a coextrudate, or forming a laminate of each separate polymer film A1, A2 and optionally A3, which have been shaped from the melts in step iv), to give a layer structure having a first outer side AS1 formed by the first polymer film A1 and a second outer side AS2 opposite the first outer side AS1;
vi) optionally introducing a security feature A5 selected from the group consisting of a hologram, a security thread, a fluorescent fiber, a dye, a pigment, carbon black, metallic or non-metallic micro- or nanoparticles, magnetic particles or a combination of at least two of these into or onto one of the polymer films A1, A2 or A3;
vii) printing at least the outer side AS1 of the layer structure from step v) formed from the first polymer film A1 with an ink dissolved in organic solvents and optionally cured via UV light, to give the security document S;
viii) optionally joining, preferably by ultrasonic welding, vibratory welding or laser welding, a polymer layer A6 to one of the outer layers AS1 or AS2 over an area of at least 1 mm²,

wherein the second outer side AS2 is formed by one of the polymer films A2 or A3, which in each case comprises or consists of a TPE, preferably a TPU.

The providing of the first polymer A1′ in step i), of the second polymer A2′ in step ii) and/or optionally of the further polymer A3′ in step iii) may take place in any way known to the person skilled in the art.

It is preferable when the providing in step i), ii) and/or iii) is effected by introducing pellets of the respective polymer into an extruder or another instrument in which polymer may subsequently be melted.

Step iv) comprises melting the polymers from step i), ii) and optionally iii) preferably by heating the extruder with the extruder screw switched on. Step v) comprises combining the polymer melts from step iv). This is preferably done by means of a die suitable therefor. Alternatively, the melts from step iv) may also be successively applied to a substrate.

The melts in step v) are preferably co-extruded via a die in the form of extruded melts or formed as individual polymer films by casting. It is preferable when the melts are extruded in step v).

If the melts are each separately formed into the polymer films A1, A2 or A3, they are joined preferably by lamination to afford the security document S in the form of a laminate. If the melts are extruded together using a die in step v), the result after full cooling of the melts is the security document S in the form of an extruded film or coextruded film. The viscosity of the melts is preferably in a range suitable for polymer processing, in particular for flat film production, of between 20 and 2000 Pa s, preferably in the range from 50 to 1000 Pa s, particularly preferably in the range from 75 to 500 Pa s. It is immaterial whether the polymer melt is a polymer with a defined melting point Tm or a defined melting interval Tm±ΔT or whether it is a polymer without a defined melting point. It is preferable when in the extrusion, in particular at the point of exiting the nozzle, the polymer has been heated sufficiently above the melting point Tm or the glass transition point Tg that the viscosity of the polymer is reduced sufficiently to allow processing to afford a polymer film.

During the extrusion of the melts in step v), it is preferable to introduce at least one further film between the individual melts as security feature A5 in step vi). The at least one supplied film preferably has a thickness in a range from 5 to 35 μm, more preferably from 7 to 25 μm, particularly preferably from 10 to 20 μm. This at least one further film may be introduced over the entire width of the melts in step v) or else only over a section of the melts. It is preferable when the at least one further film has a width which corresponds to 30% to 100%, more preferably 40% to 90%, particularly preferably 50% to 80%, of the width of the melt. The at least one further film is preferably used to introduce the security feature A5.

After the extrusion of the polymer melts of the polymers A1′, A2′ and optionally A3′ through the die to form a film, the extruded film is preferably guided onto two rolls. It is preferable for one or both rolls to possess a ductile surface. This allows a more homogeneous pressure distribution over the total width of the extrudate. This may be advantageous especially when the thin film supplied in the roll nip and serving as security feature A5 has cutouts or printed symbols in an ink layer thickness up to 20 μm, in the region of which the pressure over the rolls may vary, owing to the absence or an excess of material. Ductile rolls can compensate for this pressure difference, thus resulting in improved adhesion even in these regions. Such rolls are, for example, PTFE-coated or PTFE-sheathed rubber rolls or silicone-coated rolls.

Step vi) preferably comprises introducing a further security feature A5 into the resultant security document S by embossing, in the form of an embossment P. The embossing is preferably carried out by means of a metal embossing punch, for example in the form of a cylinder or a flat metal sheet. The embossing stamp is pressed onto one side of the multilayer film with a pressure of 40 N/cm² to 800 N/cm² at a temperature in a range from 15 °C to 80 °C, and so the embossment P is visible and tangible on the outer side AS1 or AS2 of the security document S in one of the polymer films, A1 or A3. The introduction of embossing structures is already known from EP 2 599 637 A2. In contrast to that, embossing takes place here in security documents S which no longer contain a layer of paper but only comprise films made of polymers. This increases the resolution of the embossing, but above all reduces the standard deviation of the embossing. Preferably, structures with a resolution of 40 to 500 μm, particularly preferably of 45 to 400 μm, very preferably of 50 to 300 μm, most preferably of 55 to 200 μm can be achieved. Preferably, a ratio of relief height of the embossing tool to the engraving depth in a range from 50% to 90%, further preferably from 55% to 85%, particularly preferably from 60% to 80%, most preferably from 65% to 75% is achieved, even at an engraving depth of <100 μm or of 50 to 100 μm.

As already mentioned earlier on, any combinations of security features A5 may be incorporated in the resulting security document S. Examples preferably include: flecking fibers, planchettes, metal fibers, taggants, IR or UV dyes, security pigments, fluorescent dyes, effect pigments or security threads, wherein these security features A5 are added as an additive to the pellet-form polymer mixture in step i) or to the melt in step iv), or in step v) are introduced by scattering in the vicinity of the roll nip or blown onto the melt tail, or in the case of the security thread or a security foil are guided into the roll nip. It is equally possible to provide a security feature A5 in the thin supplied film. This allows the security features already known from the field of paper banknotes to be used without further modification, as described in DE 6 98 33 653 T2, in particular in claim 1, or in CH 704 788 A1 on page 7. Security features known from paper documents include: security threads, OVD, flecking fibers, security pigments, iridescent color applications, chips, especially RFID chips, magnetic strips.

It is alternatively preferable to employ a gravure roll as one of the rolls.

Extrusion is preferably carried out on the basis of a simple melt of a reacted polymer. It may alternatively be preferable to use a prepolymer, as described in CH 704 788 A1, as a starting material to form one of the polymer films A1, A2 or optionally A3. The prepolymer is preferably supplied before or after the roll nip to a further melt of a polymer which forms one of the other polymer films A1, A2 or optionally A3. The prepolymer is subsequently subjected to chemical or physical curing and/or reaction and/or gelling. The present invention further relates to a multilayer substrate, as may be produced in an above-described process, or as is in fact produced by a process as described above.

It is preferable when a linear pressure in a range from 0 to 500 N/cm, more preferably from 250 to 450 N/cm, is applied between the roll pair immediately after introduction of the melt. The roll pair is preferably kept at a temperature above room temperature, preferably in a range from 50 °C to 180 °C, more preferably from 60 °C to 120 °C, particularly preferably from 70 °C to 100 °C. The roll temperature ideally should not be above the melting temperature or above the glass transition point of the materials used for the resulting polymer films A1, A2 or optionally A3. It is preferable to employ a temperature of the rolls just below the glass transition point Tg and/or the melting point Tm of the lowest melting point polymer. If the melt in step v) is composed of reacted polymers then the roll temperatures may also be just above the melting temperature or above the glass transition point.

The introducing of the security feature A5 in step vi) may take place in any manner known to the person skilled in the art. The introducing of the security feature A5 in step vi) is preferably via a measure selected from the group consisting of mixing a security thread, a fluorescent fiber, a dye, a pigment, carbon black, metallic or non-metallic micro- or nanoparticles, magnetic particles, an embossing or a combination of at least two of these with the respective polymer A1′, A2′ or A3′, preferably in the melt thereof in step iv), introducing a hologram into the coextruded film or into the laminate from step v).

In step vii), the polymer film A1 is printed, preferably in the form of a coextruded film or a laminate from step v) by means of a process selected from the group consisting of offset printing, flexo printing, screen printing, digital printing, intaglio printing or a combination of at least two of them. Preferably, at least one line is applied by printing on the first outer side AS1 of the security document S, this line, in its resolution, line sharpness and thickness, being suitable even for printing banknotes. Preferably, the print layer A4 produced by printing has the properties as they are recited in connection with the security document S according to the invention.

Alternatively or in addition, the introducing of the security feature A5 may be accomplished in the form of embossing on one of the polymer layers A1, A2 or A3.

Fibers A6 may optionally be introduced into, between or onto the melts. These may also be applied to the formed multilayer film as a distinct ply or joined thereto. The fibers A6 are preferably introduced into the melt of the polymers A1′ or A3′.

The optional joining of the further polymer layer A7 onto one of the outer layers AS1 or AS2 in step vii) over an area of at least 1 mm² may be accomplished by any joining method known to the person skilled in the art for the joining of polymer films. The joining method is preferably ultrasonic welding, vibratory welding, laser welding or a combination of at least two of these. The polymer layer A7 is for example the data page of a passport.

The configuration of the polymer films A1, A2 and optionally A3 corresponds to the polymer films as specified in connection with the security document S according to the invention. More particularly, the composition, thickness, length and width and also the shape and properties are the same as described previously for the polymer films A1, A2 and optionally A3.

It is preferable for all polymer films A1, A2 and A3 to consist exclusively of polymers. It is preferable for the complete security document S except for the security feature A5 and optionally the fibers A6 to consist of polymers.

One advantage of the process according to the invention for producing a security document S lies in the high flexibility in terms of varying the polymers to be processed. Changes in material are possible in the shortest possible timeframes, thus also facilitating the production of smaller batch sizes. In addition the polymer pellets may be easily admixed before extrusion with taggants in the form of a security feature A5 such as dyes, security pigments, fluorescent dyes, effect pigments, interference pigments, metal pigments, reactive dyes, but also with further adjuvants such as UV absorbers, stabilizers and further additives, in particular those as already described in connection with the security document S according to the invention, preferably in the form of a masterbatch, which allows simple individualization, protection from environmental influences and further securing of the security document S. The selection and amount of the various security features A5 are apparent from the foregoing in respect of the security document S according to the invention and likewise apply to the process according to the invention.

As already above for the security document S according to the invention, preferred materials therefor are, in particular, plastics from the group of thermoplastic elastomers, for example thermoplastic polyurethanes, copolyesters, polyether-block-amides, thermoplastic polyolefins, styrene block copolymers and mixtures of at least two of the recited polymers. On account of their chemical structure, these exhibit particularly good compatibility in extrusion, coextrusion and the production of blends. After combining during the extrusion, lamination or coating they therefore exhibit a particularly intimate bond which is based firstly on good cohesion and secondly on good compatibility of the individual components. Further advantageous properties of a polymeric material for a security document S according to the invention are high chemical resistance toward acids, bases, solvents, bleaches, etc., high thermal stability and UV stability, high opacity, high bending fatigue strength and high softening temperatures.

Film composites produced by extrusion lamination are typically constructed such that the thin film to be laminated on, for example film A1 made of polymer A1′, is guided on a roughened, heated or cooled metal roll and the melt of the second polymer, for example A2′, from the slot die is pressed against the first metal roll via a rubber-clad roughened roll, thus pressing the polymer melt onto the supplied film. The textures of the roughened surfaces of the rolls are transferred to the molten polymer as well as to the supplied film to be laminated. A cooling of the temperature-controlled roll pair to below the solidification temperature of the polymer prevents adhesion of the film to the rubber roll. Since the polymer A1′, A2′ or optionally A3′ comes into contact with the supplied thin film A1, A2 or optionally A3 directly in molten form, the influence of heat on the supplied film is short in duration and thus hardly detrimental. The presented polymer film, for example polymer film A1, preferably comprises a TPU, onto which the melt of a PC is applied. It is possible to operate with comparatively high melt temperatures in the range from 200 °C to 250 °C. This has the advantage that the high temperature of the melt makes it possible to achieve a lower melt viscosity, thus leading to a better and faster joining of the plastics layers and allowing a more intimate bond as required for a security document S. This simultaneously allows faster process speeds.

It is preferable when the roll pair comprises temperature-controllable rolls having a matte surface which is transferred to the extruded layer composite to a certain extent during the extrusion. It is also possible to employ two metal rolls as an alternative to a roll pair composed of one rubber roll and one metal roll. Matte surfaces are especially to be understood as meaning those having a roughness in a range from 10 to 30 μm.

If two metal rolls are used, it is preferable for one of the two metal rolls to be thin-walled and under hydraulic pressure from the inside. This causes this metal roll to function like a rubber roll since in the case of thickenings, such as printing with thick color layers etc., it can undergo local deformation.

Metal rolls with surfaces polished to a high shine produce films with correspondingly smooth surfaces. These films are not very suitable for security printing because they stick together and are printable at high speeds only with great difficulty. These films are typically separated with ionized compressed air before being supplied to the printing machine. An alternative to polished rolls are rolls which have only locally polished areas which can later be found for example in certain places on the security document S, such as banknotes.

In the production of the security document S by coextrusion of at least three polymer films A1, A2 and A3 in a symmetrical structure, for example with an inner polymer film A2 of a polymer A2′ and a respective outer polymer film A1 or A3 of a polymer A1′ or A3′, wherein polymers A1′ and A3′ are particularly preferably identical, the softening temperature of the outer polymer A1′ or A3′ is preferably below that of the inner polymer A2′. Alternatively the outer polymer A1′ or A3′ has a lower melt viscosity than the inner polymer A2′ under the given processing conditions. This makes it possible through suitable selection of the outer polymer to optimize the printability of the resulting security document S. For the inner polymer film A2 it is preferable to select a polymer A2′ for optimized mechanical properties of the film. Such a multilayer polymer ply is preferably made up of largely compatible, i.e. easily coextrudable, polymers such as thermoplastic polyurethanes (TPU), copolyesters, polyether block amides, thermoplastic polyolefins, styrene block copolymers and mixtures of at least two of these.

It is preferable when additional material is incorporated between the polymer films A1 or A3 and A2 during the production process for the security document S. It is preferable to include a security thread in the feed to the roll nip as a security feature A5 which is thus securely co-incorporated between the individual plies. The thread is ideally provided with an adhesive, as is not unusual for security threads, and is thus bonded to one of the outer polymer films A1 or A3 via the heated roll.

Additional, preferably symmetrically structured security documents S which have 1 to 15 films are also preferred. Particularly preferred are security documents S with an odd number of films, in particular three or five films, with an illustrative structure having a sequence of the polymer films of A1, A2, A3, A2, A1.

In a preferred embodiment of the process, at least one of the polymers selected from the group consisting of the polymer A1′, the polymer A2′, optionally the polymer A3′ is a polymer selected from the group consisting of a thermoplastic polyamide elastomer, an olefin-based thermoplastic elastomer, preferably PP/EPDM, a thermoplastic styrene block copolymer (SBS, SEBS, SEPS, SEEPS and MBS), a thermoplastic polyurethane (TPU), a copolyester elastomer, a polyether-block-amide, a copolyester, a polycarbonate, a polyethylene terephthalate (PET), a polyethylene terephthalate glycol (PETG) or a mixture of at least two of these, preferably TPU. Examples of these materials have already been described in the description of the security document S according to the invention and likewise apply to the materials employed in the process according to the invention.

It is preferable when the second polymer film A2 comprises a polymer selected from the group consisting of a TPE, a copolyester, a polyether-block-amide or a mixture of at least two of these in an amount in a range from 50% to 100% by weight, preferably from 60% to 90% by weight, more preferably from 70% to 80% by weight, based on the total weight of the polymer film A2.

It is preferable when the first polymer film A1 comprises the TPE in an amount in a range from 50% to 100% by weight, preferably from 60% to 90% by weight, more preferably from 70% to 80% by weight, based on the total weight of the polymer film A1.

Furthermore, at least one of the polymers A1′, A2′ or A3′ comprises further additives for various purposes, such as UV protection, easier processing, coloring, etc. Examples of customary additives especially include those as already described in connection with the security document S according to the invention, or those as listed in the patent application having the application number PCT/EP2022/083290 on pages 28 to 31.

The polymers A1′, A2′ and/or A3′ are obtained by mixing the correspondingly selected aforementioned additives with the starting materials for the polymers A1′, A2′ and/or A3′. It is preferable when the polymers A1′, A2′ and/or A3′ comprise one or more of the aforementioned additives in each case in an amount in a range from 0.01% to 10% by weight, more preferably from 0.05% to 5% by weight, particularly preferably from 0.1% to 3% by weight, based on the total weight of the respective polymer A1′, A2′ and/or A3′. Mixing may be accomplished in any manner by known techniques, for example via kneaders or screw machines. Further-processing takes place by the known techniques of thermoplastics processing, for example by extrusion or injection molding.

In a preferred embodiment of the process, a further layer is applied to at least one side AS1 or AS2 of the security document S, wherein the further layer is preferably a paper, a fiber composite, a textile or a combination of at least two of these. This makes it possible to provide a security document S which is used for example as an “end-page” in passports. The end-page refers to the outermost page stitched together with further films which is bonded to the passport cover.

A further aspect of the invention relates to the use of a thermoplastic polyurethane having a hardness in a range from 80 Shore A to 95 Shore D, preferably from 85 Shore A to 90 Shore D, more preferably from 90 Shore A to 85 Shore D, very preferably from 60 Shore D to 90 Shore D, for producing a polymer film A1 which can be printed with a resolution of 20 μm to 500 μm with dyes of the class of offset printing inks, flexo printing inks, screen printing inks, digital printing inks or inks for intaglio printing.

Preferably, the polymer film A1 is the first polymer film A1 as described previously in connection with the security document S according to the invention. Preferably, the polymer film A1 is a constituent of the previously described security document S.

A further aspect of the invention relates to the use of the security document S according to the invention or produced by the process according to the invention as a banknote, birth certificate, postage stamp, tax stamp, visa pages of a passport, hinge for the data page of a passport, carrier layer of an electromagnetic shielding in a passport. The security document S is used preferably for production as a banknote or the visa page of a passport.

### EXAMPLES

Production of Two Masterbatches with 30% TiO₂.

### Masterbatch: Compounding a Highly Concentrated TiO₂ Masterbatch

The masterbatches for the production of the polymer films A1 or A3 were produced with a conventional twin-screw compounding extruder (ZSK 32) at customary TPU processing temperatures of 190 °C to 250 °C.
a) A masterbatch a) having the following composition was compounded and pelletized:
   70% by weight of Desmopan™ 9365D from Covestro Deutschland AG, Germany
   30% by weight of Kronos 2260 TiO₂ from Kronos Titan GmbH, Germany
b) A masterbatch b) having the following composition was compounded and pelletized:
   70% by weight of Desmopan™ 9385D from Covestro Deutschland AG (Germany)
   30% by weight of Kronos® 2260 TiO₂ from Kronos Titan GmbH, Germany

Production of the extruded or coextruded film for Examples 1) to 4) included a system with the following parameters:
An extruder a) for single-layer films made of A1′ or two extruders a) and b) for coextruding polymers A1′ and A2′, the extruders containing at least one screw of 60 mm diameter (D) and a length of 33 D and the screws having a degassing zone;
a melt pump;
a crosshead;
a multilayer block;
a slot die of 450 mm width;
a three-roll smoothing calender with horizontal roll arrangement, wherein the third roll can be tilted by +/−45° relative to the horizontal;
a roller conveyor;
a thickness measuring system;
a device for double-sided application of protective film;
a take-off device;
a winding station.

### Example 1) Production of a Single-Layer TPU Film of Hardness Shore 65D, Thickness 90 μm as Polymer Film A1 According to the Invention

Pellets of the plastic Desmopan™ 9365D from Covestro Deutschland AG (Germany) were conveyed from the dryer into the fill hopper of the extruder a).

In the plasticizing system, i.e. the barrel and the screw of the extruder, the Desmopan™ 9365D was melted at customary TPU processing temperatures of 190 °C to 250 °C, in particular 210 to 240 °C, and pressures of 10 to 1500 bar, preferably 500 bar. The resulting melt conveyed from the screw to the slot die then passed on to the smoothing calendar. The final shaping and cooling of the film took place on the smoothing calender (consisting of three rolls). A matted steel roll and a matted silicone-rubber roll were used for embossing of the surfaces. The rubber roll used for texturing the film surface is disclosed in U.S. Pat. No. 4,368,240 of Nauta Roll Corporation. The film was subsequently transported through a haul-off and then the film was wound up on a roll.

The first polymer film A1 shaped from the Desmopan™ 9365D was then printed according to the printing process described below.

### Example 2) Production of a Single-Layer TPU Film of Hardness Shore 85D, Thickness 90 μm as Polymer Film A1 According to the Invention

This film was produced like the film in Example 1), but with the plastic pellets Desmopan™ 9385D from Covestro Deutschland AG (Germany).

The first polymer film A1 shaped from the Desmopan™ 9385D was then printed according to the printing process described below.

### Example 3) Production of a Three-Layer White TPU Film, Thickness 90 μm as a Layer Structure According to the Invention with Polymer Film A1 and Polymer Film A2

### Production of Coextruded Film:

The pellets of masterbatch a) were conveyed from the dryer into the fill hopper a) of the extruder a). In addition, pellets of the plastic Desmopan™ 9365D from Covestro Deutschland AG were conveyed into the fill hopper a) of the extruder a).

The pellets of masterbatch b) were conveyed from the dryer into the fill hopper b) of the extruder b).

The following weight ratio of masterbatch a) to Desmopan™ 9365D in the fill hopper a) was established:
50% by weight of masterbatch a) white
50% by weight of Desmopan™ 9365D.

Also conveyed into the fill hopper b) of the extruder b) were pellets of the plastic Desmopan™ 9385D from Covestro Deutschland AG.

The following weight ratio of masterbatch b) to Desmopan™ 9385D in the fill hopper b) was established:
50% by weight of masterbatch b) white;
50% by weight of Desmopan™ 9385D

In the barrel/screw plasticizing system of the extruders, the materials were melted and conveyed at processing temperatures customary for most TPEs, in particular TPUs, of 190 °C to 250 °C, in particular 210 to 240 °C, and pressures of 10 to 1500 bar, preferably 500 bar. The materials from extruder a) and extruder b) were combined in the slot die in the form of a multilayer block to form a trilayer structure of the extruded film. The material from extruder a) formed the two outer layers, these being the first polymer film A1 and further polymer film A3, in a thickness of 15 μm in each case, and the melt from the extruder b) formed the middle layer in the form of the second polymer film A2, in a thickness of 50 μm. To this end, the melts from extruders a) and b) passed via the slot die onto the smoothing calender. The final shaping and cooling of the film took place on the smoothing calender (consisting of three rolls). A matted steel roll and a matted silicone-rubber roll were used for embossing of the surfaces. The rubber roll used for texturing the film surface is disclosed in U.S. Pat. No. 4,368,240 of Nauta Roll Corporation. The film was subsequently transported through a haul-off and then the film was wound up on a roll. The first polymer film A1 shaped from the Desmopan™ 9365D was then printed according to the printing process described below.

### Example 3a) Production of a Three-Layer White TPU Film, Thickness 90 μm as a Layer Structure According to the Invention with Polymer Film A1 and Polymer Film A2

For this example, the same materials and conditions were used as for Example 3, using the Desmopan™ 9365D for the inner layer and the Desmopan™ 9385D for the two outer layers.

### Example 4) Production of a Single-Layer TPU Film of Hardness Shore 85A, Thickness 90 μm as Polymer Film A1 According to the Invention

This film was produced like the film in Example 1), but with the plastic pellets Elastollan® 1185A from BASF (Germany).

The first polymer film A1 shaped from the Elastollan® 1185A was then printed according to the printing process described below (Printing process).

### Example 5) Film of Oriented Polypropylene (BOPP), Uncoated, Transparent, Thickness 75 μm

### Example 6) Film of Oriented Polypropylene (BOPP), Coated, Thickness 90 Um

### Printing Process

### Printing of Films and Assessment of Printed Image Sharpness

Printing ink: Sicpa offset printing ink 3SB dark blue.
Printing machine: Challenger 173 from Schlafli AG.
Nominal line width 150 μm for horizontal lines, nominal line widths 170 μm for vertical lines, nominal line width 200 μm for oblique lines.
Printing substrate: 90 μm TPU film of hardness Shore 85A to Shore 85D from Examples 1) to 4) according to the invention and the non-invention examples from Table 1.
Conditions: Room temperature 23 °C, standard pressure between 1010 and 1020 mbar

All specimens were printed with the same machine settings. Information such as contact pressure or printing speed was not displayed by the machine and could be adjusted only within a small range. Therefore, only relative statements can be made about the printed image on the various substrates.

As the photos from FIGS. 1a to 1b, 2a to 2c, 3a to 3c, 4a to 4c for Examples 1 to 4 show, the sharpness of the lines increases with increasing hardness of the TPU printing substrate.

However, with increasing hardness of the printing substrate, the foldability, creasing and smoothing property decrease.

Particularly good results with regard to printability, particularly sharpness of the print image, in combination with good folding, creasing and smoothing properties, as shown in Table 1, were afforded by the printing substrate according to the invention from Example 3, with a combination of at least one soft first polymer layer 1 and a harder polymer layer 2.

Relaxation Capacity after Folding and Creasing

The printing substrates from Examples 1) to 6) were folded in a size of DIN A6 and creased up in the hand to form a closed fist. Subsequently, the substrates were unfolded and smoothed with the palm of the hand. The samples from Examples 1) to 6) thereafter remained on a flat surface for 72 hours and then the height of the creases was measured. The results for this are listed in Table 1.

TABLE 1
Results for the relaxation capacity after folding and creasing of Examples 1) to 6)

| Printing substrate | (Example 1) | (Example 2) | (Example 3) | (Example 4) | (Example 5) | (Example 6) |
|---|---|---|---|---|---|---|
| Relaxation capacity | 1 | 5 | 1 | 1 | 5 | 5 |
| after creasing | | | | | | |
| [mm/72 hours] | | | | | | |

As can be clearly seen, Examples 1, 2, 3 and 4 according to the invention have the same (Example 2) or significantly better relaxability (Examples 1, 3 and 4) than the non-invention Examples 5 and 6, since the height of the creases, at 1, is lower than that of BOPP, at 5.

### Abrasion Test: Adhesion of the Printing Ink to the Printing Substrate

The printing substrates from Examples 1) to 4) according to the invention and the non-invention Examples 5 and 6 were tested for their abrasion behavior on the Abrex abrasion tester for printing ink adhesion. A metal mandrel was pressed here onto the printed substrate with a force of 10 newtons. Under the specified contact pressure, the machine carried out 10 strokes, on a friction path of 10 mm. The repetition rate for the strokes was 1.2 Hz.

The printing substrates from Examples 1) to 4) show significantly better ink adhesion than Examples 5 and 6 of the non-invention substrates, as can be seen on the photos in FIGS. 1c, 2c, 3c and 4c in comparison to FIGS. 5c and 6c. The films according to the invention from Examples 1 and 3 provided the best combination of ink adhesion and good foldability and creasing property.

### Embossability of the Printing Substrate

The following printing substrates were tested for their embossability. Embossing was performed without ink. This process is also known as “blind stamping”.

Substrate a) was the 90 μm TPU coex film according to the invention from Example 3, with a TPU of Shore hardness D65 on the outside and a TPU of Shore hardness D85 in the core.

Substrate b) was a 90 μm TPU coex film from Example 3a, with a TPU of Shore hardness D85 on the outside and Shore hardness D65 in the core.

Substrate c) was a film in the thickness of 90 μm Shore 85A made of TPU according to Example 4.

Substrate d) was a film in the thickness of 90 μm made of coated BOPP according to Example 6.

Substrate e) was a film in the thickness of 90 μm made of standard banknote paper (euro banknote).

The brass printing plate had line-shaped engravings in a width of 250 μm. The depth of the engravings was 50 μm to 200 μm in steps of 50 μm. Embossing took place on a flat press from Bürkle with a pressure of 300 N/cm² and at a temperature of 80 °C. The contact time was 2 seconds.

Table 2 lists the results of the embossing of substrates a) to e).

TABLE 2
Results of relief transfer when embossing reliefs
of different depths into substrates a) to e)

| | | | | | Ratio of |
|---|---|---|---|---|---|
| | Depth of the | Relief height; | | | relief |
| | engravings in | average of 4 | | | height to |
| | the embossing | measurements | Minimum relief | Maximum relief | engraving |
| | tool [μm] | [μm] | height [μm] | height [μm] | depth [%] |
| Substrate a) | 50 | 30.6 | 27.3 | 35.9 | 61 |
| Substrate a) | 100 | 67.1 | 51 | 81.6 | 67 |
| Substrate a) | 150 | 123.1 | 111.5 | 151.6 | 82 |
| Substrate a) | 200 | 157.8 | 138.2 | 175.8 | 79 |
| Substrate b) | 50 | 28.3 | 25.7 | 34.9 | 57 |
| Substrate b) | 100 | 64.8 | 49.5 | 79.3 | 65 |
| Substrate b) | 150 | 115.4 | 107.5 | 148.3 | 77 |
| Substrate b) | 200 | 138.5 | 125.7 | 168.7 | 69 |
| Substrate c) | 50 | 8.5 | 5.5 | 12.8 | 17 |
| Substrate c) | 100 | 18 | 18.9 | 27.6 | 18 |
| Substrate c) | 150 | 28.5 | 22.4 | 37.5 | 19 |
| Substrate c) | 200 | 36 | 25.5 | 42.3 | 18 |
| Substrate d) | 50 | 19.6 | 16.4 | 22.4 | 39 |
| Substrate d) | 100 | 40.6 | 37.1 | 44.5 | 41 |
| Substrate d) | 150 | 69.1 | 58.4 | 77 | 46 |
| Substrate d) | 200 | 87.2 | 80.6 | 102 | 44 |
| Substrate e) | 50 | — | | | |
| Substrate e) | 100 | 55.2 | 50.6 | 60.7 | 55 |
| Substrate e) | 150 | 92.6 | 83 | 104.8 | 62 |
| Substrate e) | 200 | 114.7 | 103 | 130 | 57 |

As can be seen from Table 2, the embossing structure produced with the substrates a) and b) according to the invention is highest, with values for the ratio of relief depth to engraving depth of 61% to 82% for substrate a) and of 57% to 77% for substrate b). In comparison to the non-invention substrate c), the ratio of relief height to engraving depth was 3 times higher and in comparison to substrate d) about two times higher. Even the substrate e) had a ratio of relief height to engraving depth at least 10% lower than the substrates a) and b).

### Crease Recovery Angle

The following substrates were tested for the crease recovery angle:
a) Coex film 90 μm, Shore D65 on the outside and Shore D85 in the core, according to Example 3)
a′) Single-ply TPU film in a Shore hardness of 65D, according to Example 1)
a″) Single-ply TPU film in a Shore hardness of 85D, according to Example 2)
c) Single-ply TPU film in a Shore hardness of 85A, according to Example 4)
d) BOPP plastic banknote, according to Example 5,
e) 5€ banknote

Testing was carried out according to the standard DIN53890:1972-01 on printed substrates after they had been printed as described under “Printing”. Testing was performed without drying out and only in dry condition. A very low crease recovery angle is desirable in order to keep the banknote crease-free for as long as possible, so as for example to allow it to be inserted into machines for as long as possible.

TABLE 3
Crease recovery angle measurement on substrates
a), a′), a″), c), d) and e)

| Crease recovery | | after 5 min recovery | | after 30 min recovery | |
|---|---|---|---|---|---|
| | Unit | Lengthways | Crossways | Lengthways | Crossways |
| e) | (degrees) | 31.2 | 32.7 | 36.4 | 39.7 |
| a) | (degrees) | 24.4 | 25.4 | 34.2 | 38.4 |
| a′) | (degrees) | 98.5 | 93.4 | 138 | 136.8 |
| a″) | (degrees) | 26.4 | 20.7 | 30 | 27.6 |
| c) | (degrees) | 173.1 | 173.9 | 177.7 | 177.5 |
| d | (degrees) | 85.2 | 82.9 | 102.5 | 100.8 |

The conventional banknote as substrate e) has been given right at the top in Table 3 in order to ensure better comparability with substrates a), a′) and a″) according to the invention which are listed directly below. A new banknote, produced from the film according to the invention from Example 3, here substrate a), or the film according to the invention from Example 4, here substrate a″), both showed in this property an even better crease recovery than the conventional banknote made of paper, substrate e) in this Table 3. Paper banknotes set the standard among the population. Thus the film of the invention even exceeds the requirements for conventional banknotes and is thus the most convincing for a switch from paper banknotes to banknotes made of polymer, which are significantly more environmentally friendly owing to their many times longer service life and better recycling qualities. The banknotes produced from coated BOPP, here substrate d), showed significantly higher crease recovery angles, as did very soft TPU substrates c).

### Tear Resistance

The printing substrate according to the invention from Example 3 was compared with the non-invention standard printing substrate, which is represented by the coated BOPP from Example 6. The results for this are presented in Table 4.

Testing took place in accordance with DIN 53363:2003

TABLE 4
Results for investigation of tear resistance on different substrates

| | Ts [N/mm] |
|---|---|
| Substrate d), corresponding to Example 6) | 21.9 |
| Film according to the invention made of TPU, corresponding to | 310 |
| Example 3 | |

The printing substrate according to the invention from Example 3 has a significantly higher tear resistance compared to the standard printing substrate made of BOPP from Example 6. This makes it possible to punch cutouts into the new printing substrate, which can then be glued over with a hologram film to create transparent windows in the banknote, similar to the process for euro banknotes.

### Tensile Strength, Breaking Stress, Elongation at Break, Modulus of Elasticity

The mechanical properties, measured according to ISO 527-3:1995, of the printing substrate according to the invention from Examples 1 to 3 were compared with the properties of the non-invention standard printing substrate of Example 6 and with a conventional 5 euro banknote:

TABLE 5
Results for investigations of mechanical
properties on different substrates.

| | | | | | | |
|---|---|---|---|---|---|---|
| Longitudinal | | | | | | |
| tensile test: | | | | | | |
| Modulus of | 6073 | 1290 | 2517 | 471 | 1991 | 43 |
| elasticity | | | | | | |
| in MPa | | | | | | |
| Breaking stress | 48.7 | 52.5 | 141.8 | 61.9 | 71.1 | 58.1 |
| in MPa | | | | | | |
| Elongation at | 1 | 221.2 | 63.1 | 273.6 | 186.9 | 492.5 |
| break in % | | | | | | |
| Tensile strength | 48.7 | 39.7 | 141.8 | 20 | 59.2 | 58.8 |
| in MPa | | | | | | |
| Elongation at | 1 | 4.5 | 63.1 | 8.2 | 4.3 | 492.5 |
| max. tensile | | | | | | |
| strength in % | | | | | | |
| Transverse | | | | | | |
| tensile test: | | | | | | |
| Modulus of | 1186 | 1282 | 2612 | 438 | 1845 | 38 |
| elasticity | | | | | | |
| in MPa | | | | | | |
| Breaking stress | 15.9 | 47.8 | 147 | 60.9 | 57.7 | 60.1 |
| in MPa | | | | | | |
| Elongation at | 4.4 | 230.9 | 72.4 | 307.6 | 4.3 | 469.1 |
| break in % | | | | | | |
| Tensile strength | 16 | 38.5 | 147 | 20 | 58 | 60.1 |
| in MPa | | | | | | |
| Elongation at | 4.3 | 4.3 | 72.4 | 8 | 4.2 | 469.1 |
| max. tensile | | | | | | |
| strength in % | | | | | | |

The printing substrate according to the invention from Example 3 and from Example 2 is in each case very close in its properties to the properties of a paper banknote, with Examples 1 and 4 also coming very close at least to the BOPP substrate from Example 6. All Examples i to 4 according to the invention additionally have significantly better values for the elongation at break compared to the paper banknote and to the BOPP substrate from Example 6; this, together with the good tear resistance, has a great influence on the durability of the substrates—for example, as banknotes. Thus, all substrates according to the invention, but especially the substrate according to the invention from Example 3, are the most convincing for a switch from paper banknotes to banknotes made of polymer, which are significantly more environmentally friendly owing to their many times longer service life and better recycling properties.

### Luminous Transmittance

The luminous transmittance was measured according to ISO 13468-2:2021. The printing substrate according to the invention from Example 3 was compared with the standard printing substrate “coated BOPP” from Example 6 and a 5 euro paper banknote. The printing substrate according to the invention from Example 3 had the highest opacity compared to the standards from Example 6.

TABLE 6
Results for investigations of luminous transmittance on different substrates

| | | Printing substrate of the | Standard polymer |
|---|---|---|---|
| | | invention made of TPU | printing substrate; |
| | Paper banknote | according to Example 3 | coated BOPP |
| Luminous | 21 | 14 | 28 |
| transmittance [%] | | | |

### Surface Tension

Various printing substrates according to the invention from Examples 1 to 3 were compared with the standard printing substrate, coated BOPP from Example 6, paper banknote and single-layer TPU film with a Shore hardness of 85A from Example 4. The tests were carried out in accordance with the DIN 55660 standard using two media.

TABLE 7
Results for investigations of surface tension on different substrates

| | Multilayer print | | Coated | Monofilm Shore | Monofilm Shore | Monofilm Shore |
|---|---|---|---|---|---|---|
| | substrate (Ex. 3) | Banknote paper | BOPP (Ex. 6) | 65D (Ex. 1) | 85D (Ex. 2) | 85A (Ex. 4) |
| Surface tension | 45 | 43 | 39 | 40 | 45 | 26 |
| [mN/m] | | | | | | |

The printing substrate according to the invention from Examples 2 and 3 had the highest surface tension, i.e. the best printability, compared to the standards and is therefore well suited as a banknote.

### FIGURES

FIGS. 1-2 describe preferred embodiments of the security document S and the process for production thereof, which should not be read as limiting. What the figures show is set out below.

FIG. 1a, 1b, 1c: Representation of a security document S according to the invention from Example 1 with a mono-polymer film A1 of TPU having a Shore D hardness of 65D with print layer A4 in the form of printed lines;

FIG. 2a, 2b, 2c: Representation of a security document S according to the invention from Example 2 with a mono-polymer film A1 of TPU having a Shore D hardness of 85D with print layer A4 in the form of printed lines;

FIG. 3a-3d: Representation of a security document S according to the invention (Example 3) with a polymer film A1 of TPU having a Shore D hardness of 65D and a polymer film A2 coextruded with polymer film A1 and composed of TPU having a Shore A hardness of 85D, wherein the polymer film A1 has a print layer A4 in the form of printed lines;

FIG. 4a, 4b, 4c: Representation of a security document S according to the invention from Example 4 with a polymer film A1 of TPU having a Shore A hardness of 85A with print layer A4 in the form of printed lines;

FIG. 5a, 5b, 5c: Representation of a non-invention uncoated BOPP film with printed lines;

FIG. 6a, 6b, 6c: Representation of a non-invention coated BOPP film with printed lines;

FIG. 7: A schematic representation of the process for producing a security document S according to the invention.

FIG. 1a and FIG. 1b each show a photo of a polymer film A1 110 according to the invention, consisting of a TPU of hardness Shore 65D, produced according to Example 1, printed with vertical lines 101 and 104, horizontal lines 102 and 105 and an oblique line 103 by means of an offset printer, as described above under Printing process, so as to obtain a security document S 100 according to the invention.

FIG. 1c shows a printed polymer film A1 according to Example 1 after the abrasion test method described in the “Abrasion test” above. Lines 101 and 102 look almost unchanged. Only a slight color abrasion 106 on the unprinted part of the substrate 110 can be detected.

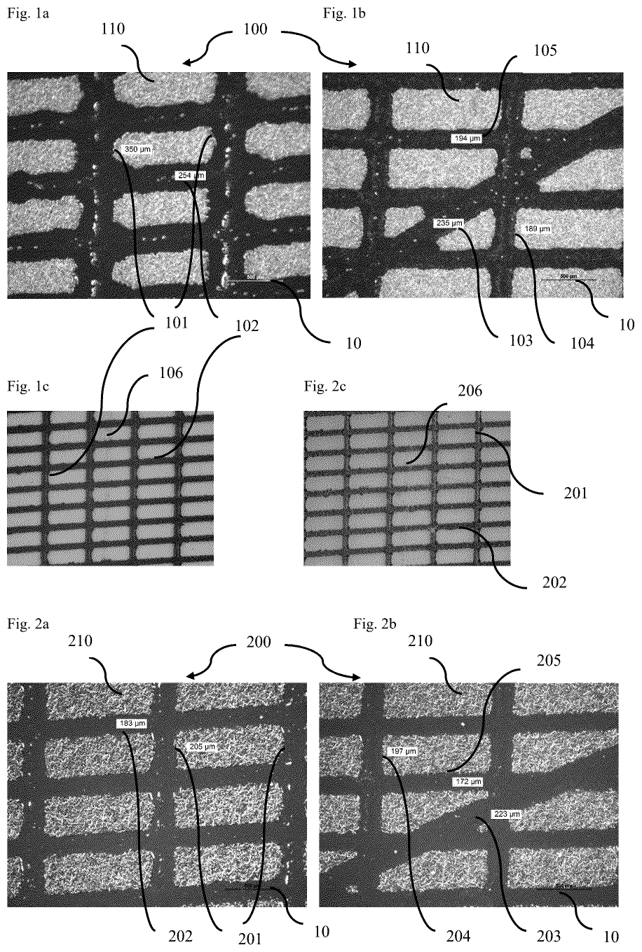

FIGS. 2a and 2b each show a photo of a polymer film A1 210 according to the invention, consisting of a TPU of hardness Shore 85D, produced according to Example 2, printed with vertical lines 201 and 204, horizontal lines 202 and 205 and an oblique line 203, as described above under Printing process, so as to obtain a security document S 200 according to the invention. FIG. 2c shows a printed polymer film A1 according to Example 2 after the abrasion test method described in the “Abrasion test” above.

Lines 201 and 202 look almost unchanged. Only a slight color abrasion 206 on a line 201 can be detected, without a significant part of color having been transferred to the substrate 110.

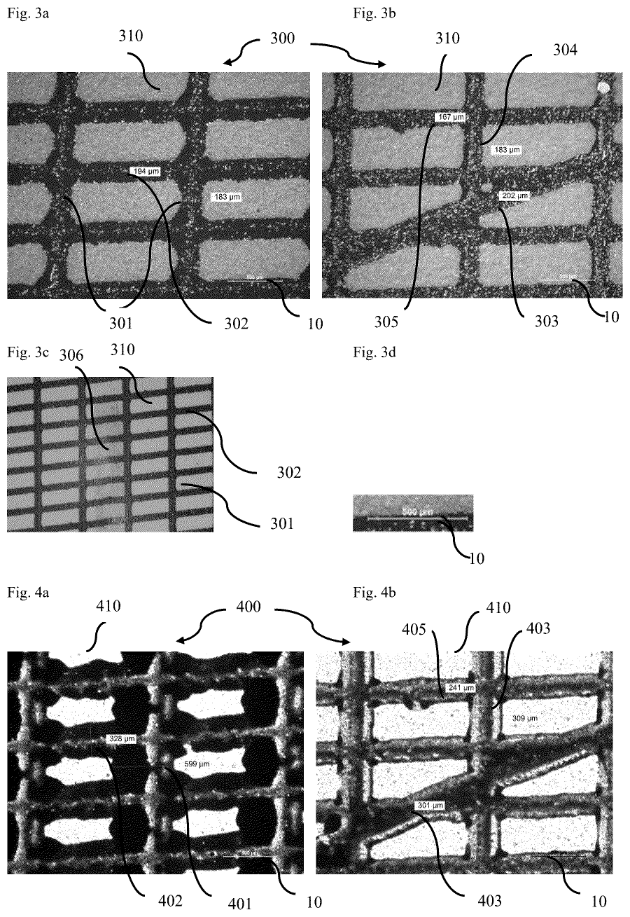

FIGS. 3a and 3b each show a photo of a polymer film A1 310 according to the invention, consisting of a TPU of hardness Shore 65D, produced according to Example 3, which was co-extruded together with a polymer film A2, consisting of a TPU of hardness Shore 85D, the polymer film A1 having been printed with lines 301 to 305, namely vertical lines 301 and 304, horizontal lines 302 and 305 and an oblique line 303, as described above under Printing process, so as to obtain a security document S 300 according to the invention. FIG. 3c shows a printed polymer film A1 according to Example 3 after the abrasion test method described in the “Abrasion test” above. Lines 301 and 302 look slightly changed. A distinct color abrasion 306 onto the substrate 310 can be detected.

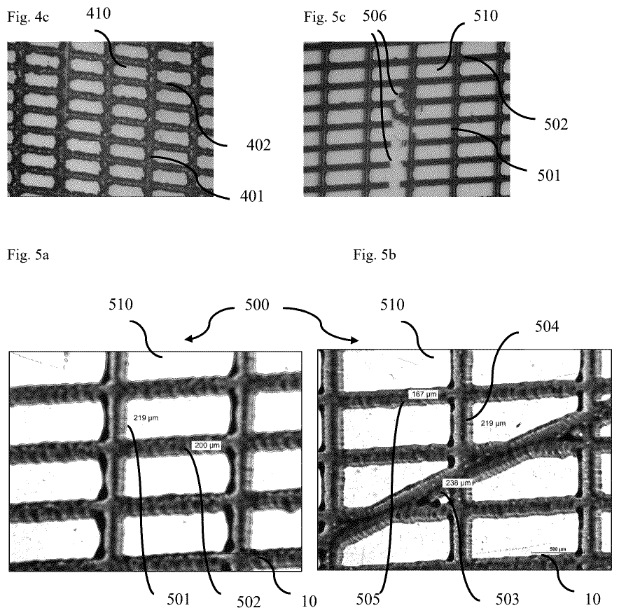

FIGS. 4a and 4b each show a photo of a polymer film 410 according to the invention, consisting of a TPU of hardness 85 Shore A, produced according to Example 4, printed with vertical lines 401 and 404, horizontal lines 402 and 405 and an oblique line 403, as described above under Printing process, so as to obtain a security document S 400 according to the invention. FIG. 4c shows a printed polymer film A1 according to Example 4 after the abrasion test method described in the “Abrasion test” above. Lines 401 and 402 look slightly faded, but there is no detectable color abrasion onto the substrate 410.

FIGS. 5a and 5b each show a photo of a non-invention polymer film 510, consisting of a bidirectionally stretched polypropylene (BOPP) from Example 5, printed with vertical lines 501 and 504, horizontal lines 502 and 505 and an oblique line 503, as described above under Printing process. Although the general deviations at the marked sites are no greater than for the examples according to the invention in FIGS. 1a, 1b, 2a, 2b and 3a and 3b, it is nevertheless clearly evident that the fluctuations of the line width within the course of the line are considerably greater than in the examples according to the invention. FIG. 5c shows a printed film according to non-invention Example 5 after the abrasion test method described in the “Abrasion test” above. Lines 501 and 502 appear to be heavily abraded at the abrasion site 506. A distinct color abrasion 506 onto the substrate 510 can be detected.

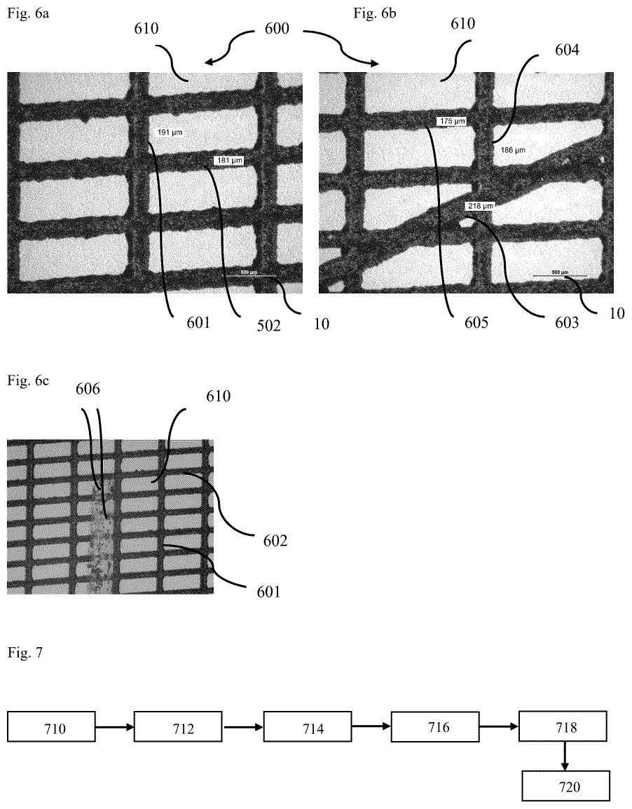

FIGS. 6a and 6b each show a photo of a non-invention polymer film 610, consisting of a coated bidirectionally stretched polypropylene (BOPP) from Example 6, printed with vertical lines 601 and 604, horizontal lines 602 and 605 and an oblique line 603, as described above under Printing process.

Although the general deviations at the marked sites are no greater than for the examples according to the invention in FIGS. 1a, 1b, 2a, 2b and 3a and 3b, it is nevertheless clearly evident that the fluctuations of the line width within the course of the line are considerably greater than in the examples according to the invention. FIG. 6c shows a printed film according to non-invention Example 6 after the abrasion test method described in the “Abrasion test” above. Lines 601 and 602 appear to be heavily abraded at the abrasion site 606. A distinct color abrasion 606 onto the substrate 610 can be detected.

On all photos, a scale 10 of 500 μm can be seen at the bottom right, which has only been elucidated in FIG. 3d by the enlargement of the photo 3a.

As shown by the width indications within FIGS. 1a, 1b, 2a, 2b, 3a, 3b, 4a, 4b, 5a, 5b, 6a, 6b, the printed lines especially on Examples 1, 2 and 3 exhibit a particularly small deviation from the respective nominal line width.

FIG. 7 shows schematically the process for producing a security document S. In step i) 710 a first polymer A1′ was provided. In step ii) 712 a second polymer A2′ was provided. The optional step iii) is not shown here. In step iv) 714 the polymers from step i) 10 and step ii) 12 were each melted in an extruder. Melting was carried out at a temperature of 250 °C and at standard pressure. In step v) 716 the polymer melts from step iv) were shaped as a coextrudate with formation of a first polymer film A1 and of a second polymer film A2 from the second polymer A2′. This was done by causing the melts from the extruders to flow through a die onto two metal rolls. Parallel to the flow of the melts from the extruder, in step vi) 718 a security thread was introduced between the melt of the polymer A1′ and the melt of the polymer A2′. After cooling of the extrudate, in step vii) 720 the first outer layer AS1 of the polymer foil A1 was printed with a blue offset ink according to the Printing process as described above. The result is shown in FIGS. 1a and 1b.

1. A security document S having a first outer side AS1 and a second outer side AS2 opposite the first outer side AS1, comprising:
A1. a first polymer film A1,
A2. optionally a second polymer film A2,
A3. optionally at least one further polymer film A3, and
A4. a print layer A4,
wherein at least the first polymer film A1 comprises a thermoplastic polyurethane TPU having a hardness in a range from 80 Shore A to 95 Shore D in an amount of50% to 100% by weight, based on the total weight of the first polymer film A1, and the first polymer film A1 forms at least the outer side AS1 of the security document S, and
wherein the print layer A4 covers the surface of the security document S in a range from 1% to 100% based on the total surface area of the surface AS1.

2. The security document S as claimed in claim 1, wherein the security document S comprises the second polymer film A2.

3. The security document S as claimed in claim 1, wherein the print layer A4 consists of printing inks selected from the group consisting of offset printing inks, flexo printing inks, screen printing inks, digital printing inks or a combination thereof.

4. The security document S as claimed in claim 1, wherein the print layer A4 has at least one of the following properties:
(D1) consists of at least one line, the at least one line having a shape selected from the group consisting of a circle, a polygon, an oval, a polygon or a combination of at least two thereof;
(D2) it has a line width of 20 μm to 500 μm;
(D3) at least one line of the print layer A4 is configured with a deviation from the nominal line width of 2 to 20 μm;
(D4) a height in a range from 0.5 μm to 15 μm;
(D5) an increased abrasion resistance.

5. The security document S as claimed in claim 1, wherein at least the first polymer film A1 has at least one of the following properties:
a. a tear resistance of 50 N/mm to 400 N/mm determined according to DIN 53363:2003-10;
b. a tensile strength of 20 MPa to 200 MPa determined according to ISO 527-3:1995;
c. a luminous transmittance of 0% to 85%, determined according to ISO 13468-2:2019;
d. a crease recovery angle of 120 to 170°, according to DIN 53890/91;
e. a Vicat softening temperature of 60 °C to 105 °C according to DIN EN ISO 306;
f. a surface tension of 32 to 55 mN/m according to DIN ISO 8296:2003.

6. The security document S as claimed in claim 1, wherein the security document S comprises at least one second polymer film A2, wherein the at least one second polymer film A2 comprises a thermoplastic elastomer TPE in an amount in of 50% to 100% by weight, based on the total weight of the respective polymer film A2.

7. The security document S as claimed in claim 5, wherein the thermoplastic elastomer TPE is selected from the group consisting of a thermoplastic polyamide elastomer, an olefin-based thermoplastic elastomer, a thermoplastic styrene block copolymer, a thermoplastic polyurethane TPU, a copolyester elastomer, a polyether-block-amide, a copolyester, a polycarbonate, a polyethylene terephthalate PET, a polyethylene terephthalate glycol PETG or a mixture of at least two thereof.

8. The security document S as claimed in claim 1, wherein all polymer films A1, A2 and optionally A3 comprise a polymer in an amount of 50% to 100% by weight, based on the total weight of the respective polymer film A1, A2 or A3.

9. The security document S as claimed in claim 1, wherein at least one of the polymer films selected from the group consisting of the second polymer film A2 or the at least one further polymer film A3 comprises a polymer selected from the group consisting of a thermoplastic polyurethane TPU, a copolyester or a mixture of at least two thereof or a mixture of TPU and at least one further TPE in an amount of 50% to 100% by weight, based on the total weight of the respective polymer film A2 or A3.

10. The security document S as claimed in claim 1, wherein the security document S has at least one of the following:
g. a tear resistance of 50 N/mm to 400 N/mm determined according to DIN 53363:2003-10;
h. a tensile strength of 20 MPa to 200 MPa determined according to ISO 527-3:1995;
i. a luminous transmittance of 0% to 85%, determined according to ISO 13468-2:2019;
j. a content of security pigments of 0.1% to 10% by weight, based on the total weight of the security document S;
k. a crease recovery angle of 120 to 170° according to DIN 53890/91;
l. a surface tension of 32 to 55 mN/m according to DIN ISO 8296:2003.

11. A process for producing a security document S having a first outer side AS1 and a second outer side AS2 opposite the first outer side AS1, comprising:
i) providing a first polymer A1′, wherein the first polymer A1′ comprises at least one TPU having a hardness of 80 Shore A to 95 Shore D in an amount of 50% to 100% by weight, based on the total weight of the polymer A1′;
ii) optionally providing a second polymer A2′;
iii) optionally providing a further polymer A3′;
iv) melting the polymers from step i), optionally ii) and optionally iii);
v) either forming a first polymer film as an extrudate from the melt of the polymer A1′ from step iv), or merging the polymer melts from step iv) to form a first polymer film A1 from the first polymer A1′, a second polymer film A2 from the second polymer A2′ and optionally a further polymer film A3 from the further polymer A3′ as a coextrudate, or forming a laminate of each separate polymer film A1, A2 and optionally A3, which have been shaped from the melts in step iv), to give a layer structure having a first outer side AS1 formed by the first polymer film A1 and a second outer side AS2 opposite the first outer side AS1;
vi) optionally introducing a security feature A5 selected from the group consisting of a hologram, a security thread, a fluorescent fiber, a dye, a pigment, carbon black, metallic or non-metallic micro- or nanoparticles, magnetic particles or a combination of at least two thereof into or onto one of the polymer films A1, A2 or A3;
vii) printing at least the outer side AS1 of the layer structure from step v) formed from the first polymer film A1 with an ink dissolved in organic solvents and optionally cured via UV light, to give the security document S;
viii) optionally joining a polymer layer A6 to one of the outer layers AS1 or AS2 over an area of at least 1 mm²,
wherein the second outer side AS2 is formed by one of the polymer films A1, A2 or A3, which in each case comprises a TPE.

12. The process as claimed in claim 11, wherein at least one of the polymers selected from the group consisting of the polymer A2′, and optionally the polymer A3′, is a polymer selected from the group consisting of a thermoplastic polyamide elastomer, an olefin-based thermoplastic elastomer, a thermoplastic styrene block copolymer, a thermoplastic polyurethane (TPU), a copolyester elastomer, a polyether-block-amide, a copolyester, a polycarbonate, a polyethylene terephthalate (PET), a polyethylene terephthalate glycol (PETG) or a mixture of at least two thereof.

13. (canceled)

14. The security document S as claimed in claim 1, wherein the security document S is a banknote, birth certificate, postage stamp, tax stamp, visa page of a passport, hinge for the data page of a passport, carrier layer of an electromagnetic shielding in a passport, or a combination of at least two thereof.
